(19) United States
(12) Patent Application Publication
(10) Pub. No.: US 2021/0225584 A1
(43) Pub. Date: Jul. 22, 2021

(54) SYSTEMS AND METHODS OF CONSTRUCTING STRUCTURES WITH ELECTROMAGNETIC CARBON NANOTUBE/GRAPHITE OR HYBRID COMPOSITE MATERIALS

(71) Applicant: Emerio Catalano, Caledon (CA)

(72) Inventor: Emerio Catalano, Caledon (CA)

(21) Appl. No.: 16/938,370

(22) Filed: Jul. 24, 2020

Related U.S. Application Data
(60) Provisional application No. 62/963,059, filed on Jan. 19, 2020.

(51) Int. Cl. H01F 41/02; C09D 163/00; C09D 1/00; H01F 6/06

(52) U.S. Cl. CPC H01F 41/02; H01F 6/06; C09D 1/00; C09D 163/00

(57) ABSTRACT

Systems and methods of automating the construction of buildings, structures and their respective finishes using lightweight superconducting electromagnetic hybrid composite materials.

### FIELD

The present specification relates generally to the use of carbon nanotube, graphene or hybrid composite materials, and more specifically relates to the preparation and use of these materials along with electricity to erect and form structures.

### BACKGROUND

The methods, procedures, and materials used in forming structures today are very similar to the methods, procedures, and materials used thousands of years ago, dating back at least to ancient Rome, ancient Greece, and the time of the building of the great pyramids with little evolution throughout the years. When broken down to its basic elements, current construction practices still use a variation of hoisting methods, a mixture of water to stone aggregates and wood to create the basic structure.

Today's construction has seen advances with the employment of sophisticated machinery, equipment and materials like steel, glass and plastics. However, the premise and principle to quarry or form the materials and erect a building or structure is undeniably very similar to ancient techniques. These construction practices do not provide more than a collection of raw materials fused together to produce a mass of inactive architecture. These inactive masses of fused materials then form part of an active and changing modern environment.

Construction practices are governed by resources, including manpower, materials, time, and finances. A designed structure or product often has many interrelated components that need to be completed and orchestrated almost perfectly, working with small margins of error (½″ tolerances over great spans) in order to achieve the end design, and to meet or exceed code compliances, all completed within defined time periods.

However, perfect harmony of thousands of components and materials in the hands of workers is rare. The fate of the work is dependent on humans to complete complex and precise tasks in a timely manner, often under time constraints, so that the next scheduled sequence of tasks can be completed. In addition, many steps in construction of a structure are completed in an uncontrolled environment on-site.

While there are many prefabricated building components in today's construction industry, most complex construction still includes a significant amount of human, on-site involvement. This makes the construction building process vulnerable to human error. As the scope of the work and the parameters and complexity of a project increases, so does the potential for mistakes.

Precise and controlled construction is desirable to preserve resources, ensure predictable and desired outcomes, and to promote safety. This is especially true when introducing a structure in an unpredictable environment, on-site and in the natural elements. The basic idea of creating a complex structure and its core components to house thousands of additional connection points and interconnecting materials leaves the door open to the possibility of having these systems, whether independent or dependent on one another, fail exponentially.

### SUMMARY

A new process of using superconducting electromagnetic carbon nanotube/graphene or hybrid composite materials for structure applications.

Aspects of the present invention may be used in the construction of structures. Example embodiments of the disclosed apparatus, systems, and methods may be used in the construction of structures such as buildings for human occupation. However, it is to be understood that other embodiments of the apparatus, systems, and methods described herein may also be applied in the construction of other structures, such as land and air vehicles, infrastructure and civil construction, such as roads, sewers, high tension towers, bridges, etc., and consumer items.

Embodiments of the construction materials and methodology disclosed herein may streamline and simplify the construction of structures. These embodiments may reduce the materials used, the number of connection points between materials, and the number of necessary on-site personnel or workers. Embodiments may also reduce the risk associated with human error during construction and associated with building component system failures in conventional construction.

Embodiments of the construction materials and methodology disclosed herein may also reflect the use and existence of electricity and electromagnetism commonly found and active in nature. This principle and its existence have fueled the technology world, giving rise to technological advances, such as many of those in devices at the turn of the century. For example, electricity and electromagnetism are commonly employed by living organisms to harness and use energy, such as trees and plants harnessing electromagnetic energy from the sun. Many advanced technological devices reflect nature's use of electricity and electromagnetism. For example, many modern advances in EV vehicles, Maglev trains, robotics and everyday smartphones reflect nature's use of electricity and electromagnetism. Many such devices provide mechanical functionality to inanimate objects in order to enhance or compliment human experience.

Embodiments disclosed herein further allow the construction of structures employing electricity and electromagnetism to create electrified and dynamic interactive structures. These embodiments may be contrasted to conventional rigid, inanimate construction materials and methods wherein materials are cast, formed, anchored, or welded into place. In embodiments disclosed herein electricity takes on a vital and active role in forming and sustaining structures moving construction practices and architecture toward an era of electrification.

However, rather than utilizing electricity to be converted into rotational mechanical force or power, as seen in various aspects of technologies such as EV vehicles with their motors, embodiments disclosed herein will use magnetic fields within a cross section or along the plane of an electromagnetic composite hybrid material. For example, embodiments employ direct mechanical force in the form of interacting magnetic fields. This is similar to the way in which Maglev train technology uses controllable superconducting electromagnetic components to levitate, support the weight of the trains, and can be used as a propulsion system.

Embodiments of the present application use hybrid carbon nanotube/graphene (“CNT”) carbon fiber, graphite textile sheets such as various proprietary and nonproprietary sheet material. This hybrid superconducting composite material may be the vehicle through which electricity and magnetic interacting fields are applied to the construction of structures.

Embodiments disclosed herein draw on the theory that certain materials, or forces for that matter if their molecules are properly arranged, can exert an exponential force relative to their weight. For example, water in liquid form does not support significant pressure or stress, however when cooled to form ice its mechanical properties change. Superconducting magnets may exhibit similar properties; when electricity is introduced into a superconducting material, and different magnetic flux field interactions are created, it can provide great force relative to their weight.

One of the key components in an electromagnetic system is the material used. For example, when a superconducting material is used to create magnetic fields, important considerations include the material's ability to efficiently conduct electricity with zero electrical resistance, how well it can stay within its critical temperatures, material strength, ductility, stability and its overall lifecycle capacity without deteriorating.

In conventional construction, buildings and structures typically employ a collection of heavy weighted construction materials to counteract and support the overall sum of heavy construction materials used above, that are bearing down on each of these individual building components. These materials must also be able to sustain lateral loading. In contrast, embodiments disclosed herein use relatively lightweight material in a constant state of high tension to counteract both the compressive and tensile live and dead loads imposed on a building structure.

In some embodiments, the hybrid superconducting material employed is in sheet format. The material may make up to 75%-100% of a building's structural core with the ability of introducing conventional cement into the system. In some embodiments, the material is infused with epoxy/resin and fire-retardant coatings. Preparation of the material may include magnetizing the material during the manufacturing stage. Magnetization may enable the material to exhibit properties of electromagnets once an alternating current runs through the material. The developed hybrid superconducting material can be laminated together to form ply's of 1-5 to form a laminar composite.

In some embodiments, developed CNT/graphene or hybrid composite material can be laminated together to form ply's of a 1-5 where required. In consideration of the former material, aligning the CNT/graphene atom lattice structures directly above each other, in a layered format, may give the laminar structure further enhanced thermal, electrical and mechanical properties. The material may possess strength capabilities and a melting point (structural degradation) greater than that of structural steel and cement used in conventional buildings, particularly when the material has been treated with 2-Stage Epoxy, Boron Nitride and fire retardant coatings. Treated CNT/graphene material may have a density and volume ratio of 10% as compared to conventional structural steel and concrete.

The inherent properties of many CNT/graphene materials include high conductivity with the ability to transfer and store electricity over long distances without losing energy. In some embodiments, CNT/graphene material may be able to store and conduct electricity while effectively diffusing or dissipating the heat that is generated from the electricity over its surface area. This is similar to the way in which layering graphite is able to be implemented in rockets as an insulator from the 5,000 degrees Fahrenheit fuel burning propellant. In some embodiments, the CNT/graphene material deployed may be both a superconductor and a supercapacitor. The properties of such CNT/graphene material, in composite form, along with its high yielding tensile strength (which may be approx. 200 mpa-1 gpa) and stable honeycomb structure makes for a useful building material in some embodiments.

In conventional construction, a typical high-rise building consisting of 102 floors may consistently have hundreds of workers on-site (based on a footprint of +26,000 sq.ft.), from the start of the project to the end. Each finished floor may have a dry weight of approx. 3,500 tons and be made up of thousands of materials joined together with connection points vulnerable to increases in torsion or rotational loads. The erection process of the building's structural shell, along with the necessary rough-ins to be completed prior to a concrete pour, may often take 1 week to complete each floor. Weather delays, subcontractor hold-ups, construction errors that need to be rectified prior to advancing, and other issues may delay the project at many stages. Such a timeframe may result in the erection of a 102-floor building taking approximately 2 years to complete. Typically, the exterior cladding and interior finishes can commence during this timeframe, and may finish a few months after the erection of the structural shell if the project is well managed and work is coordinated properly.

In contrast, the use of CNT/graphene or hybrid composite sheet material as the core structure may eliminate the need for heavy construction materials, numerous deliveries, heavy machinery or equipment, poor workmanship, human errors, design errors, weather delays, subcontractor delays, the use of numerous construction materials and contractors, and the use of numerous material connection points (fabricated and or created on-site) which compromises the structural integrity of a building. It may also drastically reduce the time required to construct a building or structure. In some embodiments, the use of a superconducting electromagnetic CNT/graphene or hybrid composite material to form the structural core of a building may reduce the number of days needed to erect a 102-floor building from 700 days or more, to a fraction of that time. The use of CNT/graphene or hybrid composite material may also reduce the total dry weight of a structure as compared to conventional construction materials and techniques.

The use of CNT/graphene or hybrid (carbon fiber/graphite) composite material may also permit the material to be prepared mainly off-site in a controlled environment at a manufacturing capacity. It may be here in the controlled manufacturing environment that the treated sheets are stitched together to form the entire building structure as one uniform structure, including the integration of all mechanical and electrical rough-ins and ‘drywall’ surface finishes. The sheets may then be folded and shipped to the construction site, where the prepared material may be hooked up to the electrical power source for the electrification process. When electrified, the compressed superconducting material may erect itself into the designed structure, once the specified and engineered amount of electrical current (such as AC current) flows through the ‘linear synchronous motor’. This process and use of new materials may reduce on-site human errors and delays inherent with all current construction practices, may simplify construction practices and methods with the use of one material as the main building component along with electricity, may reduce the need for on-site contractors such as but not limited to electrical, mechanical, sprinkler, drywall, roofing, formwork, concrete, iron worker, caulking, fireproofing, concrete finisher, security contractor, and may also reduce the need for exterior cladding and curtain wall contractors. The use of new construction practices and materials may also provide an opportunity to introduce new building systems, new industry standards, and new equipment to conform to the tensioned and lightweight nature of this building structure.

The use of superconducting electromagnetic CNT/graphene or hybrid composite materials and processes may permit buildings and other structures to function as ‘living’ and active objects; interfacing and interacting with a changing and dynamic environment. Buildings and structures may adapt and transform, and may also distribute, manage, and generate electricity from first design inception and throughout its lifecycle. The use of materials, electricity and processes described herein may assist in the automation of construction and the building of structures. Controlling the electromagnetic structure wirelessly.

In some embodiments, CNT/graphene or hybrid composite materials and related processes may allow structures and buildings to be transformed aesthetically, may be interactive to provide users with data or electricity, to consume data or electricity, or to obtain data or electricity, such as regenerating electricity back to the ‘heart’-battery packs. Structures in some embodiments may be reshaped, and may interact with interchangeable components, such as in a modular style. Advances in the efficiency and power output of battery technology, which may be a building's or structure's main energy source, may enable the superconducting and supercapacitor properties of the CNT/graphene or hybrid composite core to be utilized as beacons for energy source providers or generators.

In embodiments, the use of superconducting electromagnetic materials and processes described herein may mean that rather than having architecture solely being about a culmination of colors or material choices coming together to realize the author's design intent, a building or structure's shapes and textures may be used to create an atmosphere or environment that evokes a feeling or experience among observers, occupants, visitors and users that take in, consume and utilize the space that was created as it exists in three dimensions. This may be similar to architect Daniel Libeskin's take on architecture with his designed Jewish Museum in Berlin. Here, architecture is made to convey the story about the holocaust and make an emotional connection with the audience. Visitors undergo a set of emotions from pain, suffering, and seclusion as they experience purposefully placed spatial voids in the building, to hope, as expressed through the building's use of slit window openings that every so often flood a once-dark interior space with small amounts of natural light.

With the addition of energy, giving ‘life’ to the core of a structure or building, the structure or building may have the ability to take on new forms, adapt, interact with its audience and transform its presence and aesthetics in a changing environment. This may add a new dimension of ‘interactive and dynamic architecture’ to be consumed and experienced with the senses in an entirely new way. Architectural buildings or landmarks may be more than just inanimate structures in a vibrant, evolving, interactive environment; more than just a snapshot in space and time.

### FIGURES

A more complete understanding is to be derived from the detailed description provided herein and from the accompanying drawings of embodiments, in which:

FIG. 1A is a schematic view of a first manufacturing step using material option number 1, according to a first embodiment;

FIG. 1B is a schematic view of a second manufacturing step using material option number 1, according to a first embodiment;

FIG. 1C is a schematic view of a third manufacturing step using material option number 1, according to a first embodiment;

FIG. 1D is a blown-up detail showing construction of hybrid composite material related to material option number 1.

FIG. 1E is a schematic diagram showing a Maglev EDS and EMS train system.

FIG. 2A is a schematic view of a first manufacturing step using material option number 1, according to a second embodiment;

FIG. 2B is a schematic view of a second manufacturing step using material option number 1, according to a second embodiment;

FIG. 2C is a schematic view of a third manufacturing step using material option number 1, according to a second embodiment;

FIG. 2D is a schematic view of a fourth manufacturing step using material option number 1, according to a second embodiment;

FIG. 3A is a perspective view of a complex geometric shape construction, according to an embodiment;

FIG. 3B is a front view of the structure of FIG. 3A;

FIG. 3C is a schematic view of a manufacturing step in the construction of the shape of FIG. 3A;

FIG. 3D is a schematic view of a CNT guide rail;

FIG. 3E is a schematic view of a CNT construction;

FIG. 4A is a schematic view of a first manufacturing step using material option number 2, according to a first embodiment;

FIG. 4B is a schematic view of a second manufacturing step using material option number 2, according to a first embodiment;

FIG. 4C is a schematic view of a third manufacturing step using material option number 1, according to a first embodiment;

FIG. 4D is a blown-up detail showing construction of hybrid composite material related to material option number 2.

FIG. 4E is a detail showing different construction layouts or formats for the incorporated superconducting material as related to material option number 2.

FIG. 6 is a schematic view of a CNT/graphene (material option 1) or HCML (material option 2) core column, according to an embodiment;

FIGS. 6A to 6C are schematic views of CNT/graphene (material option 1) or HCML (material option 2) core column construction, according to embodiments;

FIG. 7A is a cross section schematic view of inter-layering CNT/graphene (material option 1) or HCML (material option 2) reinforcement components, according to an embodiment;

FIG. 7B is a cross section schematic view of CNT/graphene (material option 1) or HCML (material option 2) structure in tension with two stage coating, according to an embodiment;

FIG. 7.1A is a schematic diagram of CNT/graphene (material option 1) or HCML (material option 2) stitching detail, according to an embodiment;

FIG. 7.1B is a schematic diagram of stitched CNT/graphene (material option 1) or HCML (material option 2) composite material, according to an embodiment;

FIG. 8A is a schematic diagram of a first construction step showing site work and preparation, according to an embodiment;

FIG. 8B is a schematic diagram of a second construction step showing site work and preparation, according to an embodiment;

FIG. 8C is a schematic diagram of a third construction step showing installation of battery packs, according to an embodiment;

FIG. 8D is a schematic diagram of a fourth construction step showing installation of compressed CNT/graphene (material option 1) or HCML (material option 2), according to an embodiment;

FIG. 8E is a schematic diagram of a fifth construction step showing erection of a structure, according to an embodiment;

FIG. 8F is a schematic diagram of a sixth construction step showing a curing and inspection phase, according to an embodiment;

FIG. 9 is a schematic diagram of an expansion joint construction with integrated weepers;

FIG. 10 is a schematic perspective view of a CNT/graphene (material option 1) or HCML (material option 2) floor or wall construction, according to an embodiment;

FIG. 11A is a cross section view of a typical perimeter wall or floor assembly at building envelope using CNT/graphene (material option 1) or HCML (material option 2), according to an embodiment;

FIG. 11B is a cross section view of a CNT/graphene (material option 1) or HCML (material option 2) floor and wall fire separation assembly, according to an embodiment;

FIG. 12 is a schematic cutaway view of a CNT/graphene (material option 1) or HCML (material option 2) floor or wall construction, according to an embodiment;

FIG. 13A is a schematic perspective of CNT/graphene (material option 1) or HCML (material option 2) construction incorporating mechanical and electrical rough-in integration in ceiling and wall, according to an embodiment;

FIG. 13B are cross section and schematic views of CNT/graphene (material option 1) or HCML (material option 2) construction with plumbing integration, according to an embodiment;

FIG. 13C are cross section and schematic views of CNT/graphene (material option 1) or HCML (material option 2) construction with HVAC integration, according to an embodiment;

FIG. 14 is a schematic view of a software component of a CNT/graphene (material option 1) or HCML (material option 2) system;

FIG. 15A is a schematic perspective view of a CNT/graphene (material option 1) or HCML (material option 2) structure showing rollout of building façade, according to an embodiment;

FIG. 15B is a schematic perspective view of façade slab installation onto CNT/graphene (material option 1) or HCML (material option 2) structure during rollout of building façade, according to an embodiment;

FIG. 15C is a schematic cross section view of a CNT/graphene (material option 1) or HCML (material option 2) construction detail showing exterior perimeter wall having an epoxy fastening, according to an embodiment;

FIG. 15D is a schematic cross section view of a CNT/graphene (material option 1) or HCML (material option 2) construction detail showing exterior perimeter wall having a mechanical fastening, according to an embodiment;

FIG. 15E is a schematic cross section view of a CNT/graphene (material option 1) or HCML (material option 2) construction detail showing exterior perimeter wall having a mechanical fastening, according to an embodiment;

FIG. 16A is a schematic perspective view of a CNT/graphene (material option 1) or HCML (material option 2) structure showing rollout of building façade, according to an embodiment;

FIG. 16B is a schematic cross section view of a CNT/graphene (material option 1) or HCML (material option 2) construction detail showing epoxy grown cladding, according to an embodiment;

FIG. 17A is a schematic perspective view of CNT/graphene (material option 1) or HCML (material option 2) construction showing dynamic live wall, according to an embodiment;

FIG. 17B is a schematic perspective view of façade slab installation onto CNT/graphene (material option 1) or HCML (material option 2) structure during live wall rollout, according to an embodiment;

FIG. 18A are schematic perspective views of façades on CNT/graphene (material option 1) or HCML (material option 2) structure showing details of interactive façade material, according to an embodiment;

FIG. 18B is a cross section view of interactive façade material, according to an embodiment;

FIG. 18C is a schematic perspective view of a façade on CNT/graphene (material option 1) or HCML (material option 2) structure, according to an embodiment;

FIG. 19 is a schematic perspective view of CNT/graphene (material option 1) or HCML (material option 2) interface showing interior ‘live’ wall building interaction, according to an embodiment;

FIG. 20A is a schematic perspective view of a CNT/graphene (material option 1) or HCML (material option 2) structure showing an example of an amphitheater roof canopy in an inactive state, according to an embodiment;

FIG. 20B is a schematic perspective view of a CNT/graphene (material option 1) or HCML (material option 2) structure showing an example of an amphitheater roof canopy in a stretched state, according to an embodiment;

FIG. 20C is a schematic side view of the CNT/graphene (material option 1) or HCML (material option 2) structure of FIG. 20B;

FIGS. 21A to 21C are schematic perspective views of a CNT/graphene (material option 1) or HCML (material option 2) structure at stages of transformation, according to an embodiment;

FIG. 22 is a schematic perspective view of a CNT/graphene (material option 1) or HCML (material option 2) structure including wireless charging, according to an embodiment;

FIGS. 23A to 23C are schematic depictions of a building movement element at three stages of movement, according to an embodiment; and

FIGS. 24A to 24C are schematic diagrams of actuators.

Like reference numbers refer to like elements throughout the several drawings. It is to be understood that the invention disclosed herein is not limited to the embodiments disclosed and described, which are provided as examples only.

### DETAILED DESCRIPTION

Aspects of the present invention may be used in the construction of structures. Example embodiments of the disclosed apparatus, systems, and methods may be used in the construction of structures such as buildings for human occupation. However, it is to be understood that other embodiments of the apparatus, systems, and methods described herein may also be applied in the construction of other structures, such as land and air vehicles, infrastructure and civil construction, such as roads, railroads, aqueducts, tunnels, sewers, high tension towers, bridges, etc., as well as robotics, artificial limbs or prosthetics, and consumer items.

It is to be understood that in embodiments CNT's/graphene's natural honeycomb structure at the atomic level may need to align between adjacent or adjoining or laminating CNT/graphene sheets in order to control the laminar's electromagnetic and superconducting properties through the use of alternating current.

In embodiments, CNT/graphene (referred to material option number 1) or hybrid carbon fiber/graphite composite material (referred to material option number 2 option) may be prepared for use in the construction of buildings or other structures.

In embodiments, CNT/graphene sheets or hybrid composite materials (HCML) may be proprietarily developed to provide the required properties, such as modifying commercially available CNT/graphene, carbon fiber and graphite textiles and or other fabrics to provide the desired characteristics.

In embodiments, HCML refers to hybrid composite material laminar (material option number 2).

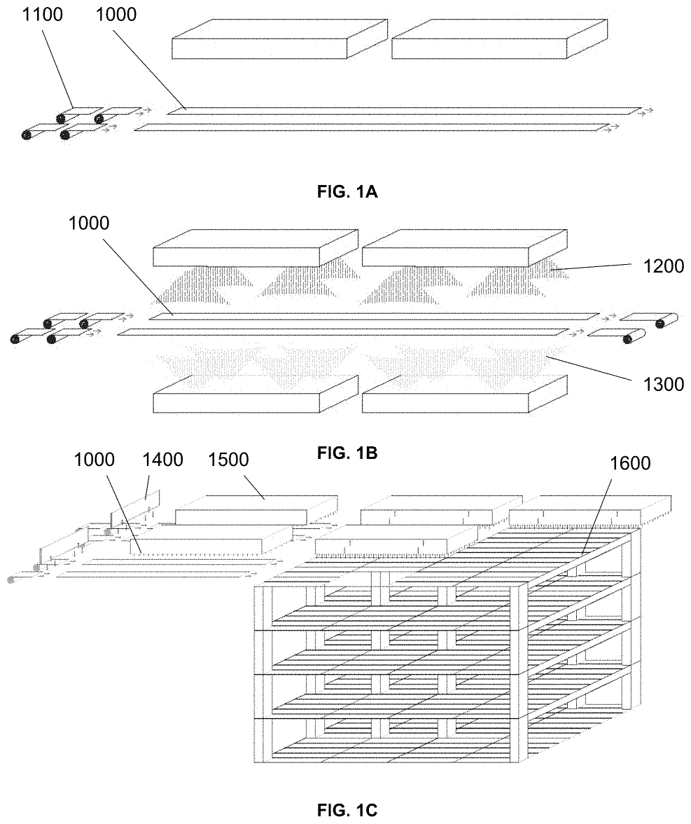

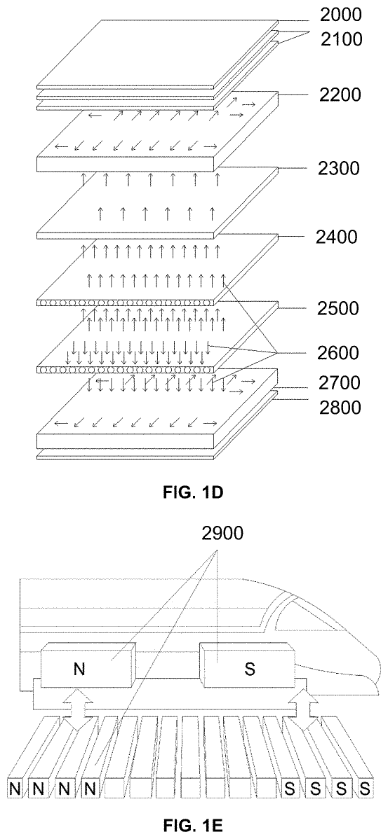

In embodiments, CNT/graphene sheets refer to specialty developed hybrid CNT/graphene laminar composite materials meeting the properties required for this invention as illustrated in FIG. 1D.

A first embodiment of the preparation of CNT/graphene material is illustrated in FIGS. 1A to 1E.

As illustrated in FIG. 1A, a first step may involve the magnetization and making base sheet material superconducting 1000, such as third party developed CNT/graphene sheet rolls 1100 (this will be known as material option number 1). Magnetization or converting CNT/graphene base sheet material 1000 into a Type 2 or 3 superconductor with a low critical operating temperature of 4-77 Kelvin may involve the following processes 1) Atomic hydrogen doping of CNT's/graphene's sublattice structure. When a hydrogen atom is added to the material it binds to one of the carbon atom's Pz orbital creating an imbalance between the sublattices and therefore creating a controllable magnetic state 2) Contact with yttrium iron garnet allows for the transfer of its ferromagnetic properties onto the CNT/graphene material 1000 3) Porphyrins molecule dry method 4) The addition of sulfur or super hydrides to make base material superconducting 5) The 1:1 magic degree twist method in a 3D material to make material superconducting. CNT/graphene experiences zero electrical resistance at room temperature in this process and liquid nitrogen cooling will not be required or 6) The addition of NbC, Type 2 Nb3 SN/NbTi, 2nd generation flexible high temperature (HTS) cuprates such as ReBCO, HBCCO, BSCCO, GdBCO superconducting wires, filaments, cables and or tapes. Once superconductivity is manufactured into the material, the laminar composite will be capable of conducting hundreds of thousands of volts and amps and with its Meissner Effect, can produce anywhere between 5-30 Tesla. During step 1, CNT/graphene material 1000 may be woven with a superalloy such as niobium or inconel in a wire or mesh format or coated with carbyne to enhance structural, thermal and corrosion properties of the laminar. During the FIG. 1A process, base sheet material 1000 will be embedded with transistors, relays, transformers, resistors, magnetic amplifiers, capacitors, sensors etc. so that voltage and ampacity loads can be controlled remotely during the construction phase and thereafter.

In some embodiments, it is to be understood that if room temperature superconductivity is achieved in the CNT/graphene composite material, liquid nitrogen cooling of the material will not be required.

It is to be understood that other methods of magnetization and making base material 1000 superconductive may also be used in some embodiments. Permanent magnetization and creating superconductivity within the base material 1000 is to create magnetic field interactions along the plane or through a cross section of the hybrid CNT/graphene laminar. This will allow the laminar system to become rigid and tensioned when an electrical current is introduced 2600. This technology is adopted from EDS/EMS Maglev trains (electrodynamic or electromagnetic suspension) with the use of passive permanent superconducting magnets located on the trains interacting with the alternating magnetic fields of superconducting electromagnets located on the rails in order to create lift and propulsion as illustrated in FIG. 1E. With 2900 illustrating both the superconducting magnets and electromagnets.

As illustrated in FIG. 1B, CNT/graphene material is then sprayed with coatings. In the embodiment illustrated, on a top side, magnetic and superconducting CNT/graphene sheets may be sprayed with an epoxy or resin or polymer 1200 to form a coating (‘epoxy’). In some embodiments, this epoxy coating may be applied as two stage coating, to form a first or inner of 1-Stage coating and a second or outer or 2-Stage coating.

Epoxy properties may be fourfold: compressive structural properties—while being flexible only at contact point between it and CNT/graphene sheets in order to allow tensioned sheets to remain in tension under electrical load; impermeable-air/water tight sealant for integrated plumbing & moisture/vapor barriers; redundant electrical & R-value insulators. Cured epoxy on the interior side of a structure may also serve as the finished seamless/uniform ‘drywall’ end product ready for paint. In some embodiments, epoxy coating may be proprietarily developed to provide the required properties, such as modifying commercially available epoxy to provide the desired characteristics.

The underside of CNT/graphene sheets is also sprayed with boron nitride solvent 1300 or an equivalent property solution (‘boron nitride’). The boron nitride coating may act primarily as an electrical & building insulator as well as fireproofing or a fire-retardant barrier. Cured boron nitride may also serve as a finished seamless/uniform ‘drywall’ end product ready for paint.

In other embodiments, other coatings may be used which have analogous properties to those of the epoxy coating and boron nitride coatings applied in this embodiment, as described further below.

As illustrated in FIG. 1C, CNT/graphene sheets are then cut and formed together as a desired structure. CNT/graphene sheets are first rough cut 1400, and then more precisely cut by laser 1500. Cut CNT/graphene sheets are then stitched together in the form of the desired structure 1600.

As illustrated in FIG. 1D, the schematic diagram shows the different layers of the CNT/graphene composite material. Whereby 2000 is the epoxy/resin or fire retardant coating, insulation & electromagnetic shielding (RF—electromagnetic radiation) layer; 2100 are the aramid, buffer and RF screen layers; 2200 is the built-up ply's of flexible conductive (RF shielding) CNT/graphene (material opt. 1) sheet layer; 2300 is the optional flexible superalloy reinforcement matrix mesh layer; 2400 is the closed loop permanent superconducting magnet phase layer consisting of flexible CNT/graphene (material opt. 1) cryostat layer; 2500 is the flexible superconducting CNT/graphene (material opt. 1) cryostat layer embedded with controls; 2600 expresses the direction of the magnetic force field; 2700 is the built-up ply's of Flexible (RF shielding) conductive CNT/graphene (material opt. 1) sheet layer and 2800 is the epoxy/resin coating, insulation and shielding layer.

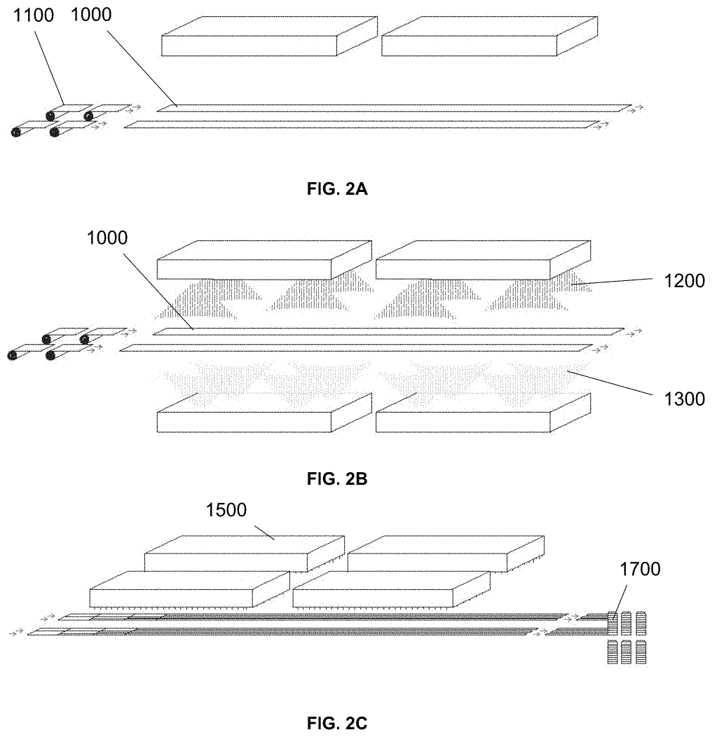

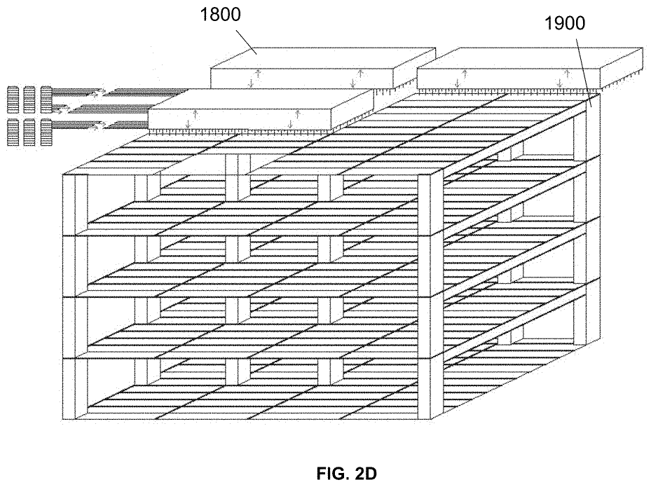

A second embodiment of the preparation of CNT/graphene material is illustrated in FIGS. 2A to 2D.

As illustrated in FIG. 2A, a first step may involve the magnetization and making base sheet material superconducting 1000, such as third party developed CNT/graphene sheet rolls 1100 (this will be known as material option number 1). Magnetization or converting CNT/graphene base sheet material 1000 into a Type 2 or 3 superconductor with a low critical operating temperature of 4-77 Kelvin may involve the following processes 1) Atomic hydrogen doping of CNT's/graphene's sublattice structure. When a hydrogen atom is added to the material it binds to one of the carbon atom's Pz orbital creating an imbalance between the sublattices and therefore creating a controllable magnetic state 2) Contact with yttrium iron garnet allows for the transfer of its ferromagnetic properties onto the CNT/graphene material 1000 3) Porphyrins molecule dry method 4) The addition of sulfur or super hydrides to make base material superconducting 5) The 1:1 magic degree twist method in a 3D material to make material superconducting. CNT/graphene experiences zero electrical resistance at room temperature in this process and liquid nitrogen cooling will not be required or 6) The addition of NbC, Type 2 Nb3 SN/NbTi, 2nd generation flexible high temperature (HTS) cuprates such as ReBCO, HBCCO, BSCCO, GdBCO superconducting wires, filaments, cables and or tapes. Once superconductivity is manufactured into the material, the laminar composite will be capable of conducting hundreds of thousands of volts and amps and with its Meissner Effect, can produce anywhere between 5-30 Tesla. During FIG. 2A process, CNT/graphene material 1000 may be woven with a superalloy such as niobium or inconel in a wire or mesh format or coated with carbyne to enhance structural, thermal and corrosion properties of the laminar.

In some embodiments, it is to be understood that if room temperature superconductivity is achieved in the CNT/graphene composite material, liquid nitrogen cooling of the material will not be required.

It is to be understood that other methods of magnetization and making base material 1000 superconductive may also be used in some embodiments. Permanent magnetization and creating superconductivity within the base material 1000 is to create magnetic field interactions along the plane or through a cross section of the hybrid CNT/graphene laminar. This will allow the laminar system to become rigid and tensioned when an electrical current is introduced 2600. This technology is adopted from EDS/EMS Maglev trains (electrodynamic or electromagnetic suspension) with the use of passive permanent superconducting magnets located on the trains interacting with the alternating magnetic fields of superconducting electromagnets located on the rails in order to create lift and propulsion as illustrated in FIG. 1E. With 2900 illustrating both the superconducting magnets and electromagnets.

As illustrated in FIG. 2B, CNT/graphene material is then sprayed with coatings. In the embodiment illustrated, on a top side, magnetic and superconducting CNT/graphene sheets may be sprayed with an epoxy or resin or polymer 1200 to form a coating (‘epoxy’). In some embodiments, this epoxy coating may be applied as two stage coating, to form a first or inner of 1-Stage coating and a second or outer or 2-Stage coating.

The epoxy coating properties may be fourfold: compressive structural properties—while being flexible only at contact point between it & CNT/graphene sheets in order to allow tensioned CNT/graphene sheets to remain in tension under electrical load; impermeable-air/water tight sealant for integrated plumbing & moisture/vapor barriers; redundant electrical & R-value insulators. Cured epoxy coating on the interior side of a building will also serve as the finished seamless/uniform ‘drywall’ end product ready for paint.

The underside of the CNT/graphene sheets are also sprayed with boron nitride solvent 1300 or an equivalent property solution (‘boron nitride’). This coating acts primarily as an electrical & building insulator as well as fireproofing and or a fire retardant barrier. Cured boron nitride may also serve as the finished seamless/uniform drywall end product ready for paint.

As illustrated in FIG. 2C, the CNT/graphene sheets may then be converted into filament yarn 1700, such as via laser cutting 1500 of the CNT/graphene sheets. The CNT/graphene filament yarn 1700 prepared for 3D printing machines. During the FIG. 2C process, base sheet material 1000 will be embedded with transistors, relays, transformers, resistors, magnetic amplifiers, capacitors, sensors etc. so that voltage and ampacity loads can be controlled remotely during the construction phase and thereafter.

As illustrated in FIG. 2D, the CNT filament yarn may then be 3D printed 1800 into a desired structure 1900. During the FIG. 2D processes, transistors, relays, transformers, resistors, magnetic amplifiers, capacitors, sensors etc. will be 3D printed onto the base sheet material 1000. These will be used to remotely control the voltage and ampacity loads during the construction phase and thereafter.

As illustrated in FIG. 1D, the schematic diagram shows the different layers of the CNT/graphene composite material. Whereby 2000 is the epoxy/resin or fire retardant coating, insulation & electromagnetic shielding (RF—electromagnetic radiation) layer; 2100 are the aramid, buffer and RF screen layers; 2200 is the built-up ply's of flexible conductive (RF shielding) CNT/graphene (material opt. 1) sheet layer; 2300 is the optional flexible superalloy reinforcement matrix mesh layer; 2400 is the closed loop permanent superconducting magnet phase layer consisting of flexible CNT/graphene (material opt. 1) cryostat layer; 2500 is the flexible superconducting CNT/graphene (material opt. 1) cryostat layer embedded with controls; 2600 expresses the direction of the magnetic force field; 2700 is the built-up ply's of Flexible (RF shielding) conductive CNT/graphene (material opt. 1) sheet layer and 2800 is the epoxy/resin coating, insulation and shielding layer.

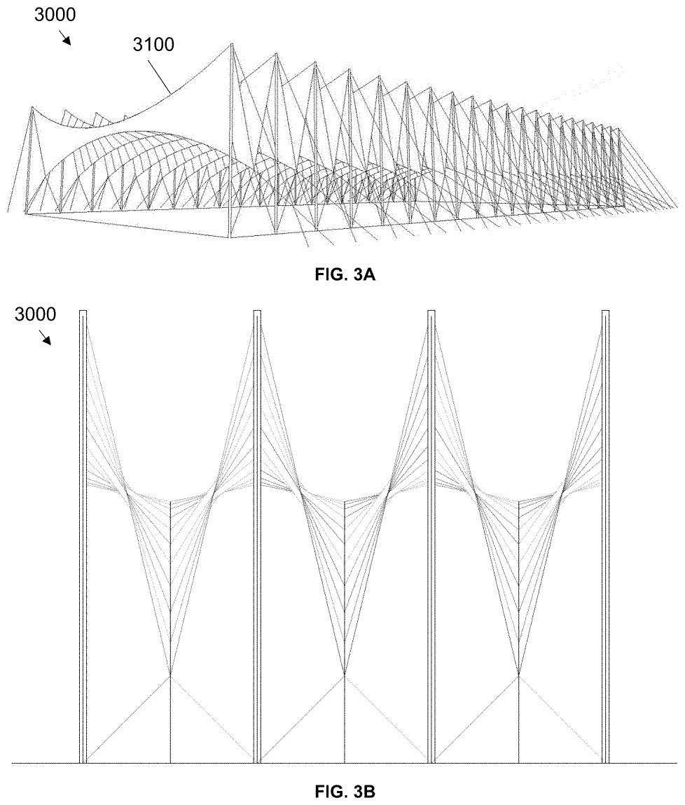

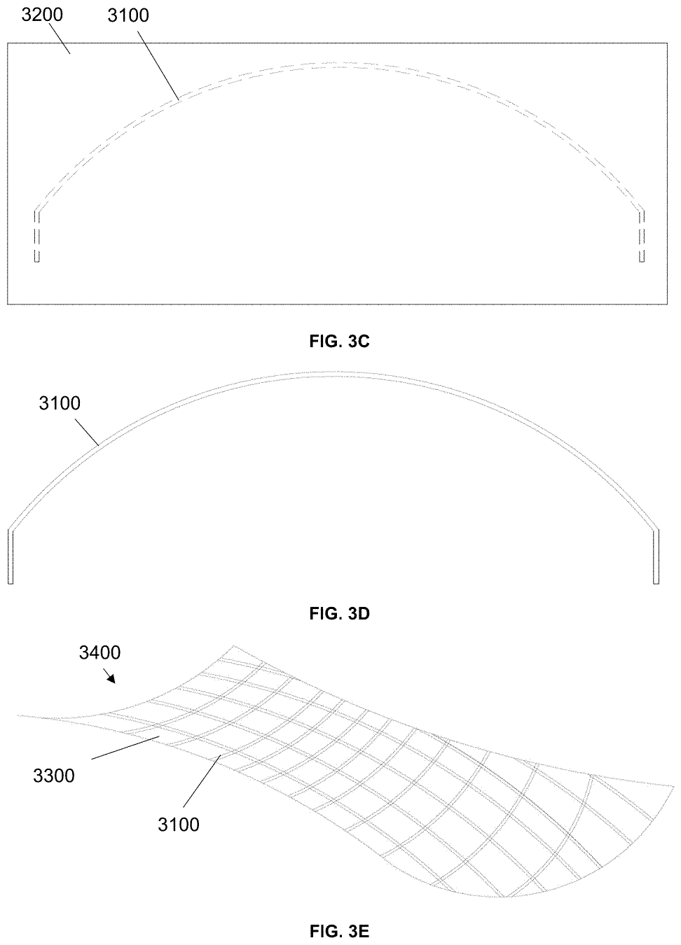

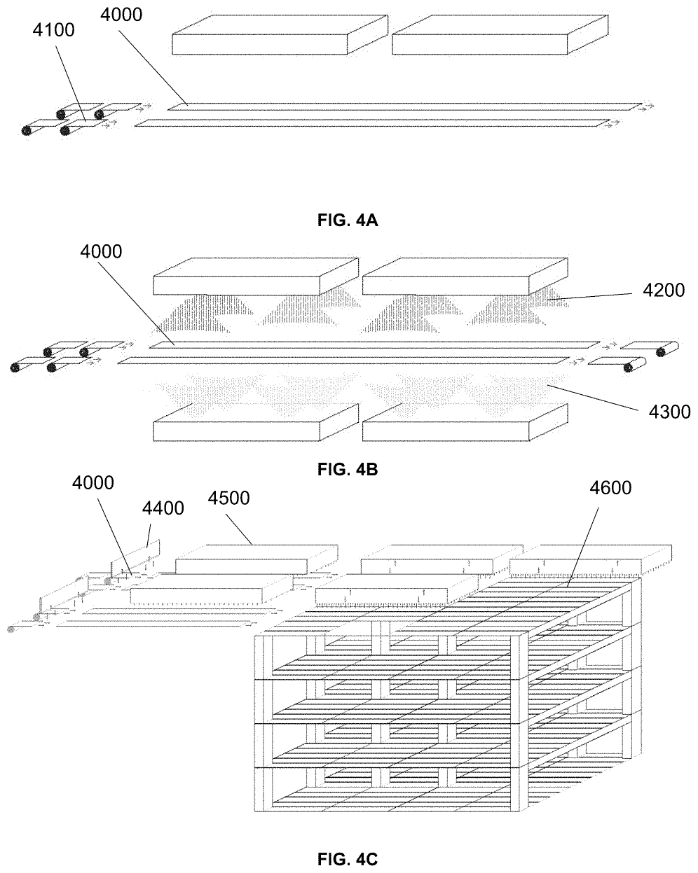

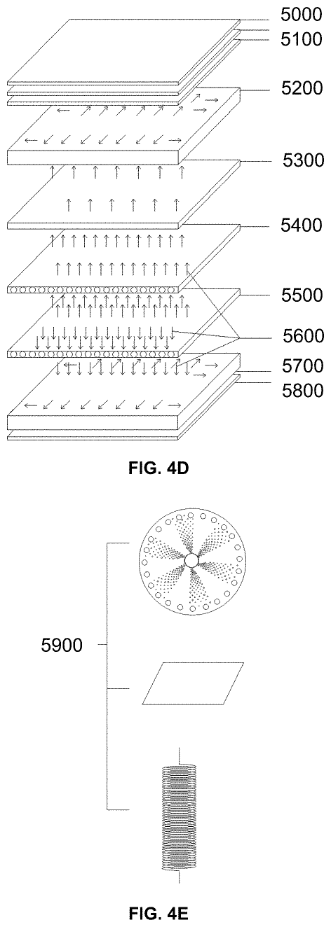

As illustrated in FIG. 3A, a finished electromagnetic CNT/graphene (material option 1) or HCML (material option 2 FIG. 4A 4000) building may be created in a complex geometric shape 3000, illustrated in front view in FIG. 3B. For example, FIGS. 3C to 3E illustrate details of the complex geometric shape construction during the manufacturing and stitching process. As illustrated in FIG. 3C, a precise guide rail component 3100 may be cut from a CNT/graphene or HCML (FIG. 4A 4000) sheet 3200 during manufacturing. As illustrated in FIG. 3D, the CNT/graphene or HCML (FIG. 4A 4000) guide rail component may be used to create the required geometric shape. As illustrated in FIG. 3E, the CNT/graphene or HCML (FIG. 4A 4000) guide rail components may be stitched together with flat plane CNT/graphene or HCML (FIG. 4A 4000) sheets 3300 in ribbed exoskeleton fashion to create the overall architectural geometry 3400.

FIG. 4A, illustrates material option number 2 which uses third party developed hybrid carbon fiber/graphite textile, fabric or sheet rolls 4100 as the base material 4000 in lieu of material option number 1 (CNT/graphene sheets FIG. 1A). Making the base material 4000 into a Type 2 or 3 superconductive with a low critical operating temperature of 4-77 Kelvin may involve the following processes 1) The Addition of sulfur or super hydrides 2) The embedding of a resistive electromagnet such as CNT/graphene or copper in a plate/sheet format 5900. Similar design to the Bitter Electromagnet 5900 sandwiched between the layers of the composite material. Alternatively, resistive conducting CNTs, graphene, copper wires or filaments can be configured in a flattened coil winding pattern 5900 embedded within the material or 3) The addition of NbC, Type 2 Nb3 SN/NbTi, 2nd generation flexible high temperature (HTS) cuprates such as ReBCO, HBCCO, BSCCO, GdBCO superconducting wires, filaments, cables and or tapes. Once superconductivity is manufactured into the material, the laminar composite will be capable of conducting hundreds of thousands of volts and amps and with its Meissner Effect, can produce anywhere between 5-30 Tesla. Hybrid carbon fiber/graphite sheet material 4000 may be woven with a superalloy such as niobium or inconel in a wire or mesh format or coated with carbyne to enhance structural, thermal and corrosion properties of the laminar. During the FIG. 4A process, base sheet material 4000 will be embedded with transistors, relays, transformers, resistors, magnetic amplifiers, capacitors, sensors etc. so that voltage and ampacity loads can be controlled remotely during the construction phase and thereafter.

In some embodiments, it is to be understood that if room temperature superconductivity is achieved in the hybrid carbon fiber/graphite composite material, liquid nitrogen cooling of the material will not be required.

It is to be understood that other methods of making base material 4000 superconductive may also be used in some embodiments. Creating superconductivity with HCML material is to create magnetic field interactions along the plane or through a cross section of the hybrid HCML laminar. This will allow the laminar system to become rigid and tensioned when an electrical current is introduced 5600. This technology is adopted from EDS/EMS Maglev trains (electrodynamic or electromagnetic suspension) with the use of passive permanent superconducting magnets located on the trains interacting with the alternating magnetic fields of superconducting electromagnets located on the rails in order to create lift and propulsion as illustrated in FIG. 1E. With 2900 illustrating both the superconducting magnets and electromagnets.

As illustrated in FIG. 4B, HCML material is then sprayed with coatings. In the embodiment illustrated, on the top side, superconducting HCML sheets may be sprayed with an epoxy or resin or polymer 4200 to form a coating (‘epoxy’). In some embodiments, this epoxy coating may be applied as two stage coating, to form a first or inner of 1-Stage coating and a second or outer or 2-Stage coating.

The epoxy coating properties may be fourfold: compressive structural properties—while being flexible only at contact point between it & HCML sheets in order to allow tensioned HCML sheets to remain in tension under electrical load; impermeable-air/water tight sealant for integrated plumbing & moisture/vapor barriers; redundant electrical & R-value insulators. Cured epoxy coating on the interior side of a building will also serve as the finished seamless/uniform ‘drywall’ end product ready for paint.

The underside of the HCML sheets are also sprayed with boron nitride solvent 4300 or an equivalent property solution (‘boron nitride’). This coating acts primarily as an electrical & building insulator as well as fireproofing and or a fire retardant barrier. Cured boron nitride may also serve as the finished seamless/uniform ‘drywall’ end product ready for paint.

In other embodiments, other coatings may be used which have analogous properties to those of the epoxy coating and boron nitride coatings applied in this embodiment, as described further below.

As illustrated in FIG. 4C, HCML sheets are then cut and formed together as a desired structure. HCML sheets are first rough cut 4400, and then more precisely cut by laser 4500. HCML sheets are then stitched together in the form of the desired structure 4600.

In other embodiments, it is to be understood that the manufacturing process as illustrated in FIG. 4C can be replaced with a 3D printing process as illustrated in FIG. 2C and FIG. 2D.

As illustrated in FIG. 4D, the schematic diagram shows the different layers of the HCML material (material option number 2). Whereby 5000 is the epoxy/resin or fire retardant coating, insulation & electromagnetic shielding (RF—electromagnetic radiation) layer; 5100 are both the aramid, buffer and RF screen layers; 5200 is the built-up ply's of flexible conductive (RF shielding) carbon fiber/graphite (material opt. 2) sheet layer; 5300 is the optional flexible superalloy reinforcement matrix mesh layer; 5400 is the closed loop permanent superconducting magnet phase layer consisting of flexible carbon fiber/graphite (material opt. 2) cryostat layer, interwoven with high temperature superconducting (HTS) wires, filaments, tapes in sheet, plate, bitter electromagnet or flattened coil windings 5900 & embedded controls; 5500 is the flexible superconducting carbon fiber/graphite (material opt. 2) cryostat layer, interwoven with high temperature superconducting (HTS) wires, filaments, tapes in sheet, plate, bitter electromagnet or flattened coil windings 5900 & embedded controls; 5600 expresses the direction of the magnetic force field; 5700 is the built-up ply's of Flexible (RF shielding) conductive carbon fiber/graphite (material opt. 2) sheet layer and 5800 is the epoxy/resin coating, insulation and shielding layer.

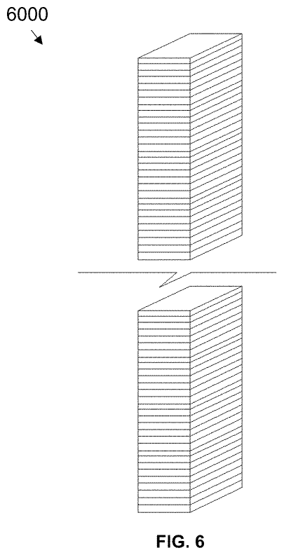

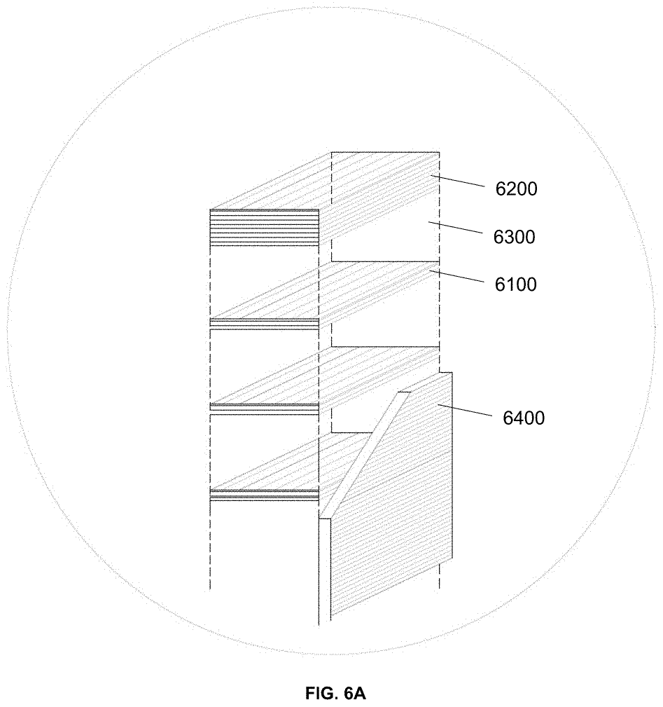

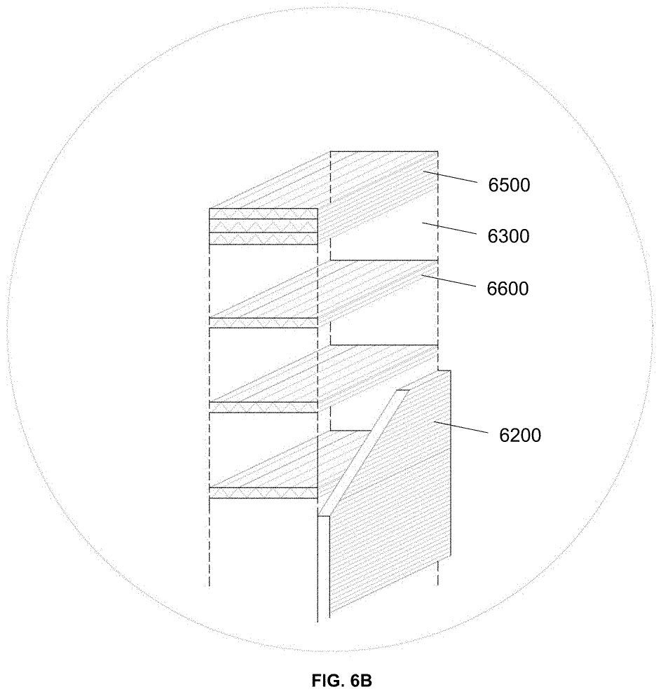

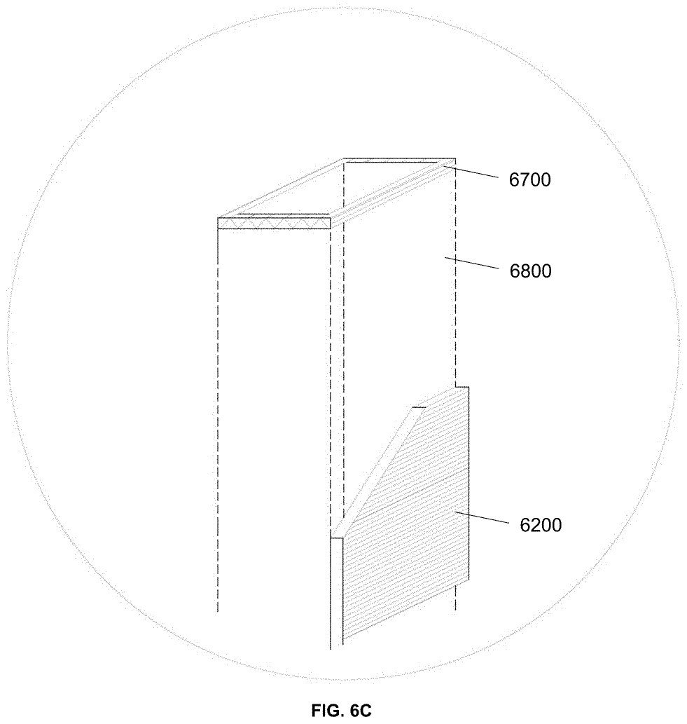

FIG. 6 illustrates a way of forming structural components, in the form of a building point load core column 6000 for point load areas of a building. Embodiments of this core column are illustrated in FIGS. 6A to 6C. The methods of forming structural components may be generalized to any structural element of a building wherever the resulting strength or flexibility or other benefits are desired and are not limited to being used to form point load core columns.

In the embodiment illustrated in FIG. 6A, the CNT/graphene or HCML core column may be formed in a composite ply of 1-3 6100 or a ply of 1-5 6200 saturated by epoxy or other coating 6300, the epoxy 6300 providing insulation and fireproofing, magnetic field shielding, water resistance and compressive structural properties. The layers of CNT/graphene or HCML sheets may be positioned in the core columns at structural load locations, and lamination of CNT/graphene or HCML sheets may be used where load locations are expected to require additional compressive strength as desired. In some embodiments, chemically, electrically, and thermally reactive coatings may expand up to 5 to 10 times their size in order to obtain the necessary insulation R-Value as engineered for specific locations of the building and or structure. The outer shell of the core column may be a single ply wall of the HCML composite sheet 6400.

In some embodiments, much like the expansion properties of open and closed cell polyurethane insulation, the expansion of the epoxy or other coatings may also offer an insulation factor. The expansion of the epoxy or other coatings is governed by the substrate it is on, namely the CNT/graphene or HCML sheet material, so it will follow the shape of the CNT/graphene or HCML material. As the electricity running through the CNT/graphene or HCML material will be controlled and uniform during the structural erection phase, and since the substrate CNT/graphene or HCML sheet material is manufactured off-site and is therefore free from imperfections and uniform in its plane, the cured epoxy or other coating will also be uniform.

It is to be understood that when material number 1 is used (CNT/graphene composite material) in addition to single layered or multilayered construction, which refers to the number of layers or sheets of CNT/graphene material used in construction, each layer or sheet of CNT/graphene material may either be single-walled or multi-walled at the atomic level. Multi-walled CNT/graphene sheets may have greater mechanical properties than single-walled sheets, however single-walled sheets may react better when magnetically charged. As a result, the desired characteristics may influence whether single-walled or multi-walled CNT/graphene material is used.

In some embodiments, during the construction process when the CNT/graphene or HCML material is electrified and tensioned or erected into place and once the coatings, such as epoxy and boron nitride coatings if these are the coatings that have been applied, are cured, the electrical current running through the building system components can be shut off. This may leave a pre-tensioned CNT/graphene or HCML structure, as the rigid properties of the coatings in their cured state holds the building in a rigid state. In some embodiments, the pre-tensioned state may be a result of the rigid properties of cured coatings combined with the properties of concrete or other conventional building materials, such as when a hybrid building process is employed FIG. 6C. When this pre-tensioning process is not employed, the CNT/graphene or HCML structural core material will be in a state of live tension with electrical current running through the system and magnetic field interactions within the material being active.

In the embodiment illustrated in FIG. 6B, the CNT/graphene or HCML core column may be formed in a composite ply of 1-3 6600 or a ply of 1-5 6500 impreg. With epoxy or other coating 6300, as applied during the manufacturing stage. The epoxy or other coating may provide insulation and fireproofing, magnetic field shielding, water resistance and compressive structural properties. In the embodiment illustrated, the CNT/graphene or HCML sheets 6500 and 6600 are layered with an integrated honeycomb or triangular substructure which will reinforce each additional layer; between the layering sheets of CNT/graphene or HCML material, triangular or honeycomb sub-structures made from CNT/graphene or HCML sheet materials are woven or stitched in between the ply's. The honeycomb or other substructure may be added to add more strength to this layered building component assembly. Triangular or honeycomb substructure may be added to take advantage of their structural properties; in geometry a triangle is the strongest shape followed by a honeycomb. For example, wooden or structural steel floor joists or roof trusses are geometrically engineered and shaped to take advantage of the structural benefits of various geometric shapes.

CNT/graphene or HCML core columns, in embodiments, may have 5 to 10% the density of steel, yet yield a stronger tensile resistance.

In the embodiment illustrated in FIG. 6C, core column formed of 1-5 ply stitched CNT/graphene or HCML sheet material 6700, with the CNT/graphene or HCML sheet material hollow in the center. This design may allow for a hybrid CNT/graphene or HCML structure approach integrated with conventional construction materials, wherein structural components that are heavily under compression and considered load bearing can receive concrete filling 6800 with reinforced CNT/graphene or HCML bracing material built into the hollow center for tensile strength. In such embodiments, CNT/graphene or HCML components may be designed to allow on-site concrete infill through the use of a built-in spout or opening integrated in the structure during the manufacturing process; Concrete to be poured into these hybrid CNT/graphene or HCML cavities after the electrical erection phase is complete. The concrete to be poured in from a high elevation and using gravitational force to work its way through the structure. Key concrete areas may be joined via connecting sloped channels or valleys to allow infill from one spout. These channels or valleys may be sprayed with a lubricant during manufacturing to assist with the flow. Electrified CNT/graphene or HCML structure, once erected and under tension, may assist with an accelerated curing time of the concrete via thermal dissipation and emission. In some embodiments, the inner cavities of these CNT/graphene or HCML structural building elements, where concrete infill will occur, will not be coated with epoxy, while outer exposed CNT/graphene or HCML sheets or ‘formwork’ will receive the standard coating treatment.

In some embodiments, channels and valleys may be sealed with one-way infill valves and pressure relief valves, to expedite the delivery of concrete through the designated routes in the system and avoid premature hardening of the concrete from the heated electromagnetic structural core. Additives to the concrete may be required to slow curing.

In some embodiments, this style of hybrid CNT/graphene or HCML hollow core assembly construction may be used in point load columns as illustrated in the example provided in FIG. 6C but also in beams, suspended floor slabs, ceilings and other structural elements.

In some embodiments, a tensioned CNT/graphene or HCML structure with this hybrid model approach may assist in speeding the construction of a conventional structure by providing the necessary formwork for the concrete. Integration with CNT/graphene or HCML components may also permit the use of substantially less concrete as CNT/graphene or HCML properties may take some of the load.

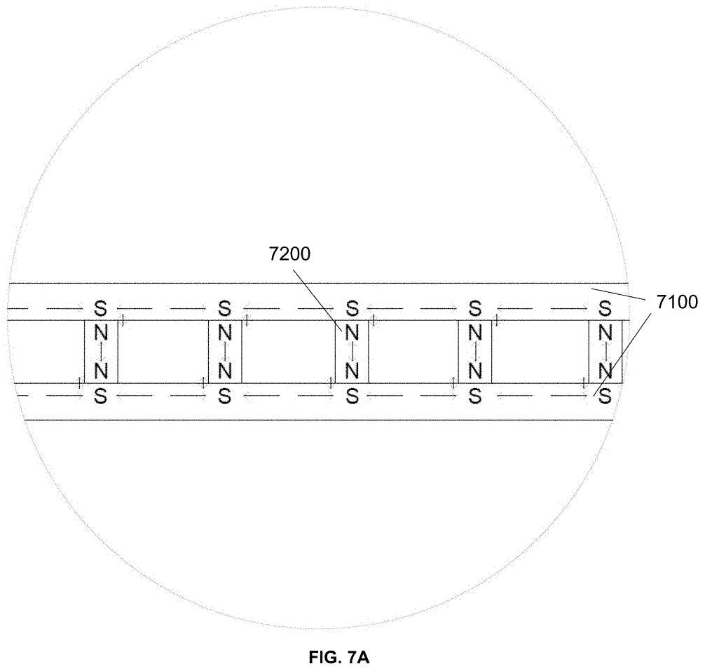

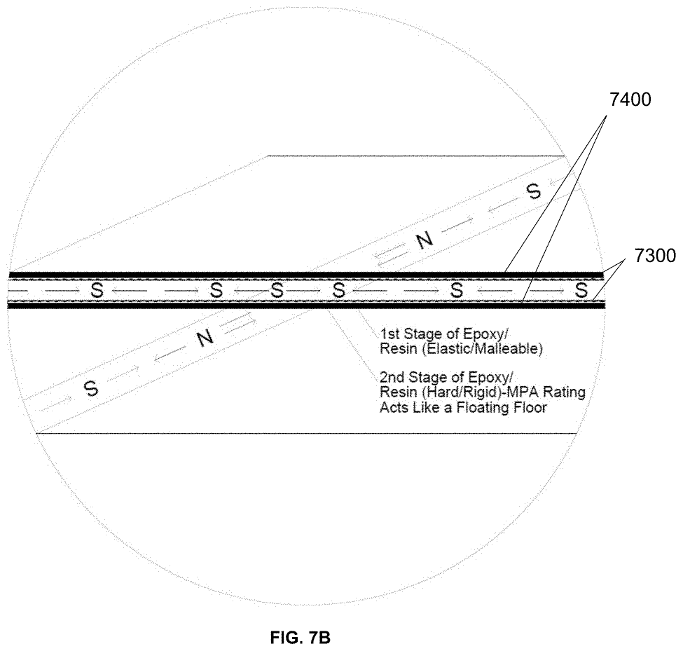

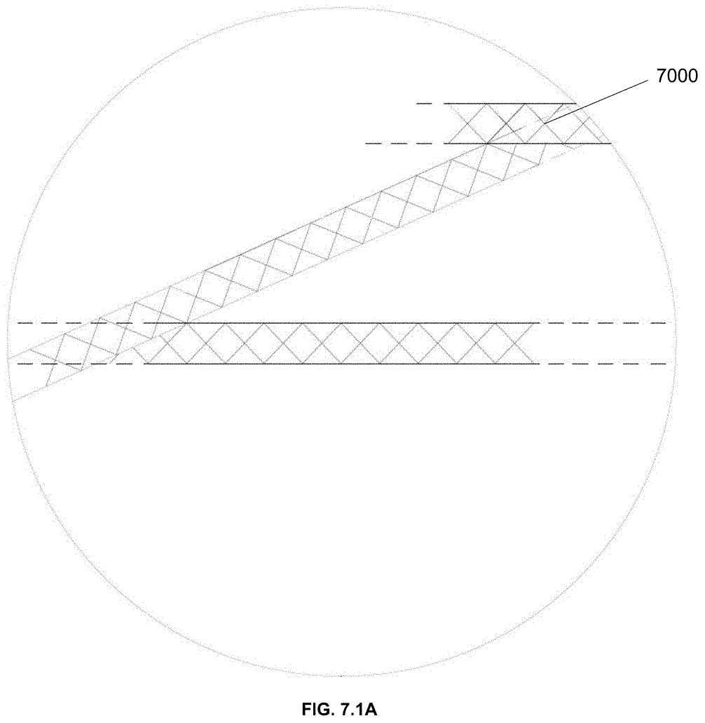

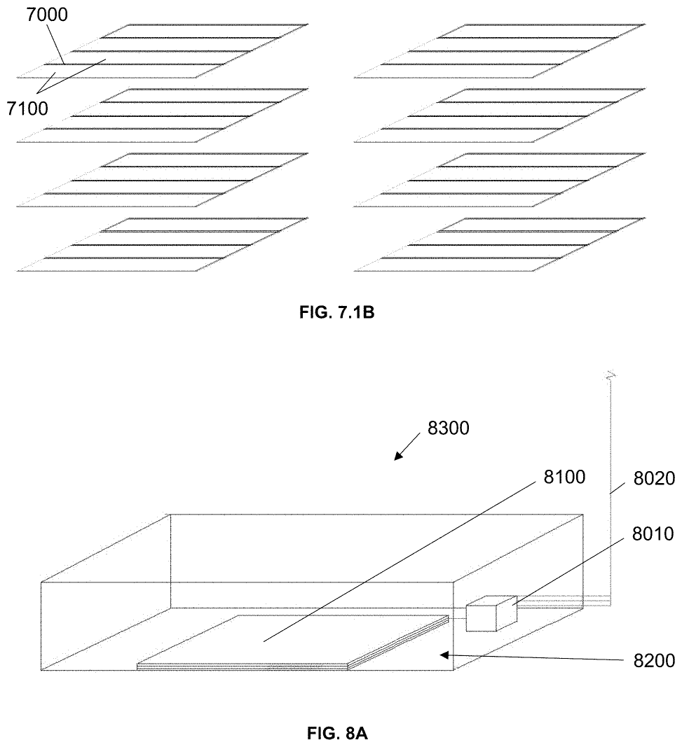

As illustrated in FIG. 7A, construction may employ fin connectors 7200 where extra compression load capability is required. Fin connectors 7200 may be sandwiched between 1 to 5 ply CNT/graphene or HCML sheets 7100, the components stitched together during manufacturing. Fin connectors 7200 may be charged with opposite magnetic field poles to the sandwiching CNT/graphene or HCML sheet layers 7100 in order to attract one another. CNT/graphene or HCML fin connectors possessing the same magnetic poles will also repel one another. This construction could also be used in the composition of floors, ceilings and roofs, where regular tensioned 1 to 5 ply laminated or layered CNT/graphene or HCML sheet and its structural epoxy coating may not be sufficient to withstand expected live and dead loads. The use of fin connectors applies pressure to the CNT/graphene or HCML sheets making the assembly more rigid, and wherein the fin connectors act as an opposing force against vertical or lateral loading.

As discussed further below, software integrated into the building automation system (BAS/BAC) may constantly monitor vertical and lateral loads through built-in sensors, and may counter increases in loads with increased electric current via built-in controls during the manufacturing phase. For example, increased vertical load may be counteracted by sending a greater electrical current to the area causing the fin connectors to provide an increased opposing vertical force, via a greater magnetic field force that pushes against the CNT/graphene or HCML walls.

Electrically controlled magnetic flux may permit responses in real time to changes in loading. For example, in hurricane, volcano, and earthquake prone areas, buildings can be designed to adjust and counteract movement and high winds. In some embodiments, CNT/graphene or HCML structures may either be pre-tensioned or may be live or actively tensioned via software, or some combination of pre and active tensioning.

In some embodiments, molecules may be trapped between the sealed highly pressurized sandwiching CNT/graphene sheet layers (where material number 1 is used) for improved mechanical properties.

As illustrated in FIG. 7B, superconducting impregnated CNT/graphene or HCML sheets under constant electrical load, such as alternating electric current passing through the CNT/graphene or HCML structure, are coated with two layers of epoxy coating. The epoxy coating, as sprayed onto the sheets during manufacturing, is chemically activated in part by the thermal transmission byproduct of electricity. The two-layer nature of the epoxy coating means that each layer may have different properties or consistencies. For example, the inner layer, or first stage, 7300 may be elastic and malleable, while the outer layer, or second stage, 7400 may be hard and stiff and act as a floating floor capable of supporting weight.

The layer closest to the CNT/graphene or HCML sheet core 7300 may stay malleable and elastic due to a designed chemical reaction or by thermal transmission with its direct proximity to the heat generated from the CNT/graphene or HCML material. This permits the CNT sheet/graphene or HCML structure to stretch and remain in tension through the electromagnetic hybrid laminar & via the controlled opposing or attracting south & north magnetic poles. These phenomena may also be present in the building construction and erection phase.

The 2nd layer of the epoxy 7400, furthest away from CNT/graphene or HCML core, stays rigid and hard once exposed to oxygen and fully cured. This layer, in addition to the structural properties of the CNT/graphene or HCML core, is what adds to the structural integrity of the assembly as a whole; and may assist in meeting or surpassing the minimum MPA rating as specified by an engineer or architect.

Epoxy coating, together with CNT/graphene or HCML structural sheet core, may have a fire resistance rating greater than conventional structural steel. Where greater fire resistance or fire-retardant materials are required in construction, as outlined by an engineer or architect, boron nitride coating or material similar in property characteristics may be used as outlined above.

While the CNT/graphene or HCML sheets possess high thermal resistance and high compressive and tensile strength without coatings, coatings, such as this 2-stage epoxy will act as a redundant fail-safe system for structural integrity and thermal resistance. However, and more importantly, the epoxy enables the electromagnetic CNT/graphene or HCML sheet structure to be safely used in this type of construction; acting as a barrier and insulator against unsafe magnetic field transmission, along with the layering electromagnetic shielding or RF shielding built into the laminar 2000, 2100, 2200, 2700, 5000, 5100, 5200—to the outside environment and the occupants.

Stitching may take the form of any stitching, including interweaving etc. which holds CNT/graphene or HCML sheets together while still maintaining the CNT/graphene or HCML material's mechanical properties. As illustrated in FIGS. 7A and 7B, stitching or interweaving 7000 may take the form of crosshatched reinforced stitching at seams to bind CNT/graphene or HCML sheets 7100 together to form one uniform structure. Stitching material may be woven CNT/graphene or HCML spools of ‘yarn’, such as made from reused CNT/graphene or HCML sheet cut-offs during the manufacturing stage.

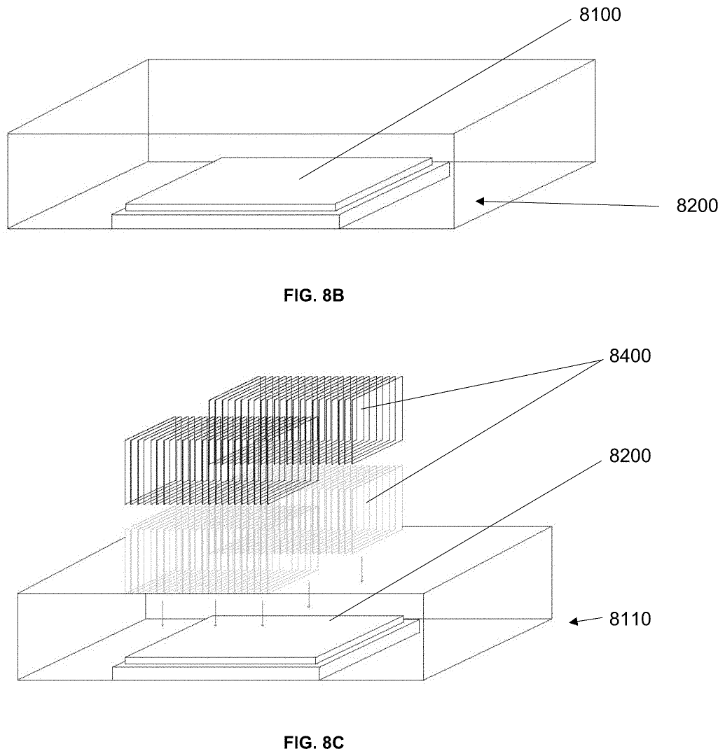

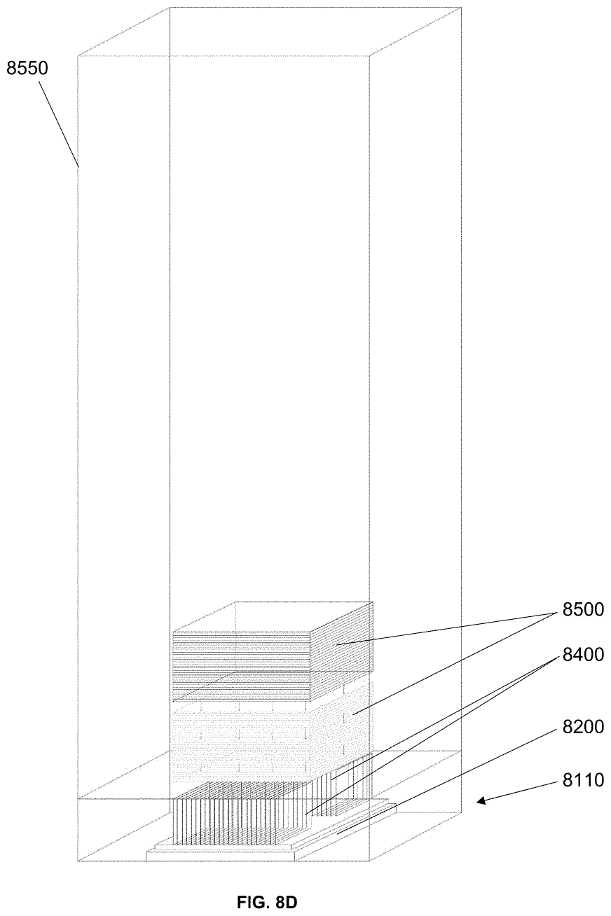

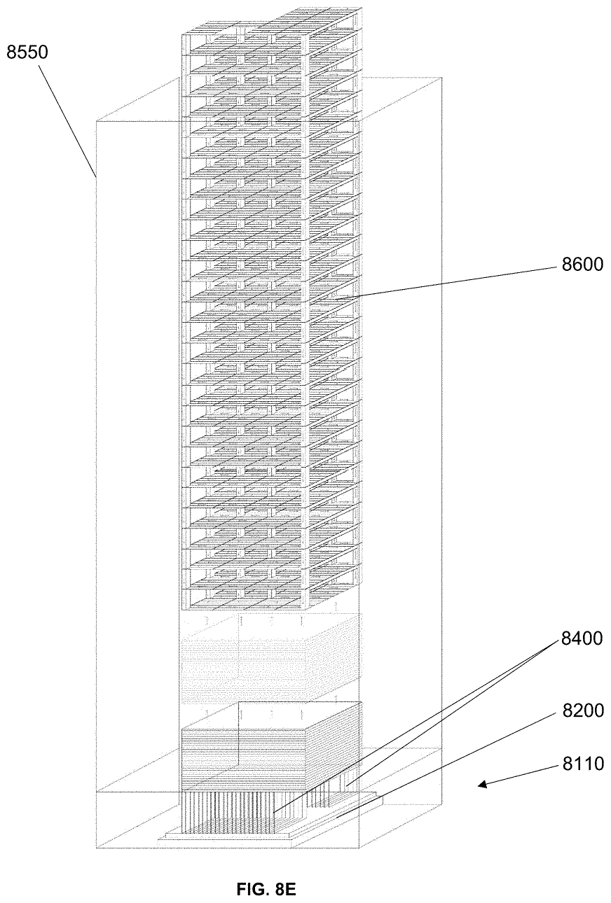

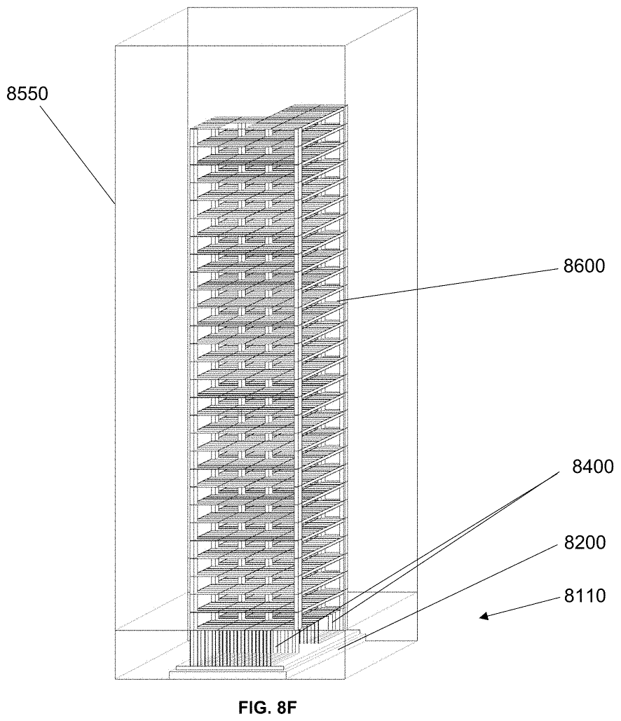

FIGS. 8A to 8F illustrate the use of CNT/graphene or HCML materials in the construction of a structure, namely a building such as a low or high-rise building.

As illustrated in FIG. 8A, CNT/graphene or HCML sheets 8100 may be used for a base foundation 8200 at an excavated site 8300. Alternatively, in some embodiments, the foundation footings may be concrete as in conventional construction. CNT/graphene or HCML sheet structures will be anchored down prior to electrification so the base does not lift when an electrical current passes through.

In some embodiments, a mobile on-site transformer 8010 may be used to step up and step down a city's electricity 8020, which may be needed for building or structure erection. In some embodiments, the foundation or base of a structure has to be completed and cured as the first stage of the construction building process so that it will be ready to accept lithium ion and or fuel cell battery packs. The battery packs may be located below grade in a mechanical room of the base foundation and may be used to complete the remaining electrification and erection of the CNT/graphene or HCML structure. In some embodiments, the base foundation is completed using concrete as in conventional construction, while in other embodiments it may be completed using the manufactured CNT/graphene or HCML sheet material as will be found in the rest of the structure. Where CNT/graphene or HCML material is used to form the base, an external electrical source, such as a city's power, may be needed to erect or cast the CNT/graphene or HCML material forming the base into place.

As illustrated in FIG. 8B, once the base material has cured, the base foundation 8200 is ready to accept batteries, such as lithium ion batteries, which will be used to erect the entire CNT/graphene or HCML structure. The batteries may be designed to remain in the building after the building has been erected and may be designed to serve as the building's primary electrical energy source with a city electrical grid to act as a back-up redundant source. The city electrical grid may also be used to recharge the batteries, such as in off-peak hours. An inverter may be installed and stationary on-site in the mechanical room and may be used to convert DC power coming from the battery packs to AC power going into the CNT/graphene or HCML material. The inverter may also be used when connecting the city's AC power from the grid system to the DC power from the battery packs. In some embodiments a twist-lock or other secure type of connection is used for the transition point from battery packs to CNT/graphene or HCML material so as not to be tampered with.

Batteries used in CNT/graphene or HCML buildings may be engineered to have a long-life cycle & operational time. Batteries may be designed to have storage capacity that will exceed any of history's worst power outages. Batteries may also be designed to work in unison with the high supercapacitor qualities of the CNT/graphene or HCML material; capable of holding an electric charge for a long period of time. The building's intelligent battery system may constantly be monitored in real-time through building software (BAS/BAC system) and may also be inspected under a regular maintenance program.

The CNT/graphene HCML structure and battery may form one large scale controllable electromagnet, encased in the epoxy coating to protect the structure from any kind of interference as well as to protect occupants and the outside environment from exposure to the magnetic fields being produced.

As illustrated in FIG. 8C, an inverter may be installed, and the system hooked up to city power. Battery packs 8400 may be supplied and may be placed on or secured to the CNT/graphene or HCML base foundation 8100 in the mechanical room 8110. The battery pack size may depend on the overall weight of structure, the required tensile strength of the structure, the overall and estimated future electrical load consumption and expandability, the battery reserve requirement, etc.; all to be calculated and specified by an engineer or designer. Battery packs may be designed to have a boost function that will draw power from the reserve for future building component automation. In some embodiments, battery packs and mechanical rooms will be safeguarded and under surveillance at all times.

The battery or mechanical room may have a stand-alone cooling system, and may be designed to be water-tight, including proper room and door seals, in case of flooding. As a redundancy, the batteries may also be waterproof and have other safety features built in.

The battery packs may serve to provide the electricity, converted to linear kinetic or momentum and thermal energy employed by the electromagnetic CNT/graphene or HCML structure.

Installation of cryogenic system in the mechanical room to occur prior FIG. 8D—the erection of the building and or structural core. Cryogenic system needed to pump and keep superconducting CNT/graphene or HCML material within its critical operating temperature to be superconducting ie. with liquid nitrogen.

As illustrated in FIG. 8D, a CNT/graphene or HCML core 8500 may then be installed. CNT/graphene or HCML material, which may be compressed and ‘folded’ to be compact in size for ease of logistics and craning, may be delivered to site and hooked up to battery packs, such as DC battery packs, ready for the erection and curing phase.

The CNT/graphene or HCML sheet structure may be anchored down prior to erection (electrification) so sheets do not lift when the high electrical current passes through the system. The batteries, such as lithium ion battery packs 8400 in the building's mechanical room 8110, may be provided to power the entire building structure and keep CNT/graphene or HCML material in tension as required. A structure may have to be delivered and erected in stages, depending on how many floors the building may have or based on the building or structure's footprint.

A series of redundant safety measures may be built into the structure at manufacturing phase and during construction to prevent any tampering of the structure. For example, this may include the erection of Electromagnetic Field or Electromagnetic Interference (′EMF/EMF) shielding, such as shielding 8550, to allow for an uninterrupted erection of the electromagnetic building structure; to protect from magnetic field exposure, including non-ionizing radiation, to confine and secure the site while high voltages are being used for the building's erection, and to protect the site zone from outside elements such as rain, snow, debris and dust. Once the structure is erected and cured, the outer epoxy coating along with the RF Shielding layers within the composite material may serve as a shielding agent instead of other safety measures, or in addition to other safety measures. In some embodiments the CNT/graphene or HCML structure may be designed to withstand potential EMP (electromagnetic pulse) attacks.

As illustrated in FIG. 8E, the structure may then be erected. For example, power output of the lithium ion battery packs may be adjusted based on the building's specific structure. Electrical energy from battery packs could enable magnetic field interactions to occur in-plane or through a cross-section of the manufactured electromagnetic CNT/graphene or HCML material, thus moving the CNT/graphene or HCML material upward in a linear fashion like a controllable linear synchronous motor. With the embedding of transformers, magnetic amplifiers, transistors, relays, resistors etc. during the manufacturing stage into the composite material; erecting the entire building 8600 as the CNT/graphene or HCML structural components become stiff and rigid, with the lithium ion battery packs in the foundation mechanical room powering the entire building structure and keeping the CNT/graphene or HCML material in a state of live tension as required. Tensioned structural CNT/graphene or HCML material components may be connected to point load areas via suspended slabs, 2-way beam, truss systems, etc. In some embodiments, the use of material resonance frequency may assist in the erection of the structure and stiffness of the CNT/graphene or HCML material into its designed location.

In some embodiments, depending on how many floors the building will be and the total power output capacity of the battery packs in the foundation, a temporary battery pack may need to be installed, such as half way up the erection process to further erect the remaining structure. This may be like an electrical jumper system. This may require waiting until the below structure has fully cured and been inspected.

As illustrated in FIG. 8F, the building 8600 may then undergo a curing and inspection phase. This may involve allowing the elapse of a curing time for the epoxy coating or other coatings, inspection of the building, mechanical and electrical rough-ins, fire and safety inspections, structural inspections, etc. After this, the building may be ready for building exterior and interior finishes and electrical, plumbing, and HVAC terminations and fixtures.

The erection of EMF/EMI (electromagnetic field and electromagnetic interference) and heat shielding solution may allow for an uninterrupted erection of the electromagnetic building structure. These may protect from magnetic field exposure, such non-ionizing radiation, and may confine or secure the site while high voltage is used for the building's erection, and may protect the site zone from outside elements such as rain, snow, debris and dust. Once structure is erected and cured, outer epoxy coating may serve as shielding agent instead or in addition to other EMF/EMI and heat shielding solutions.

Once a building is erected, the exterior may be clad in a cladding material, which may be the epoxy coating, or may be an additional cladding in addition or in alternative to the epoxy coating. In some embodiments, exposed CNT weepers (when material choice number 1 is used) may not be covered by layered epoxy coating. These may be built into the exterior building structure at various locations, and not to be covered by façade building material. These may be exposed to the elements in order to filter and absorb carbon dioxide in the air. For example, in some embodiments, carbon nanotubes/graphene are a nano porous membrane with pores that can allow carbon dioxide to flow through the membrane and get trapped. At the atomic level, once the carbon dioxide molecules are inside strands of hollow carbon nanotube, the material may allow for a free-flowing molecule that could be discharged. Trapped carbon dioxide may be captured and discharged, such as discharged underground into layers of permeable rock.

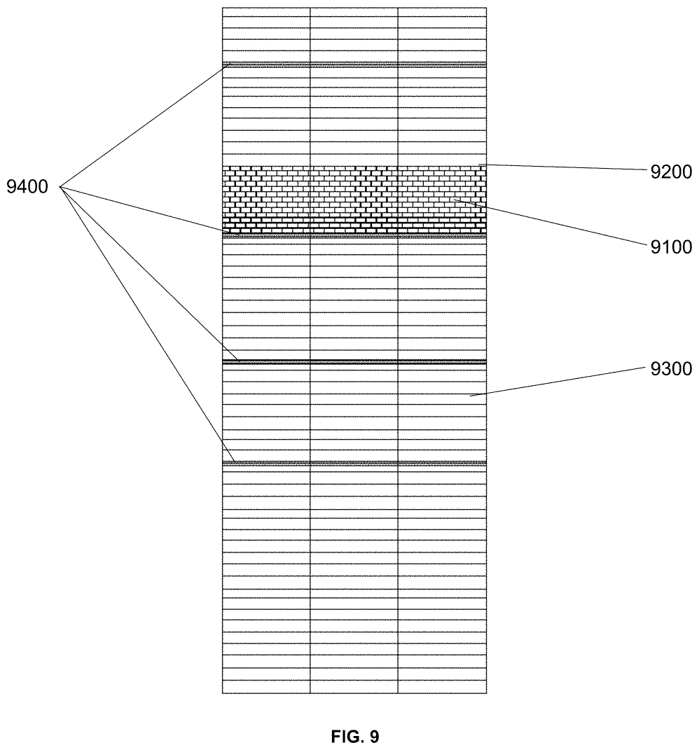

As illustrated in FIG. 9, depicting a cut away front view of a building exterior to show the CNT/graphene or HCML material structure beneath façade cladding 9100, expansion joints 9200 between pre-manufactured exterior wall cladding panels or slabs 9300 may be incorporated in the prefabricated material of choice. In some embodiments, as the core material of CNT/graphene or HCML material and coatings exhibit flexible or elastic properties (similar to the consistency of commercial rubber) where the concrete hybrid system is not used, expansion joints will only be required for the exterior building façade cladding as these materials are rigid in their construction and built-in expansion joints must allow the exterior system as a whole to expand and contract within the tolerances subject on a building structure. In some embodiments, expansion joints between cladding panels may be rubberized gaskets, similar to rubber gaskets needed in construction and on a building or structure, and may allow for minimal movement between the material make-up as a building or structure undergoes movement during its life cycle through changes in moisture in the air, changes in seasonal temperature, ground movement, settlement on the earth it is bearing down on, wind loading etc. These may be fixed in place via the epoxy melting process. Expansion joints may be rubberized membranes that will be incorporated in the prefabricated exterior cladding panels or slabs and fixed into place with epoxy. For example, epoxy or other coating may be used on the back of the panels or slabs or expansion joints, and once these are in place a chemical reaction between the coating on the panels or slabs or expansion joints may occur with the coating on the core structure to bond the two materials together. Heat may be used in binding the two epoxy coatings together, as the heat generated from the CNT/graphene or HCML structure may melt and fuse the two epoxies together. The CNT/graphene or HCML structural core may have electricity running through the system, which may generate heat, which may be increased where desired to melt the epoxy coating. Alternatively, expansion joints 9200 throughout can be achieved utilizing the stage 1 elastic epoxy coating in lieu of an actual rubberized material.

As illustrated, some CNT/graphene or HCML material may be exposed, and not treated with epoxy in the manufacturing process. These weepers 9400 may be placed at various locations of the CNT/graphene or HCML structure, and the substrate is not to be covered fully by the building façade material, so that they are exposed to the natural elements and can be used for their intended purposes; to act as a filter and extract carbon dioxide in the air. These weepers will be isolated from the electromagnetic CNT/graphene or HCML core via the boron nitride insulation that surrounds these elements as they will be exposed to moisture and water. A boron nitride coating or other non-conductive coating may be used here, to isolate from the superconducting electrified core, and this coating may not need to be flexible in the way that coating on other elements of the structure may be.

The weepers 9400 are in addition to the epoxy covered CNT/graphene or HCML structure and are not intended for structural or electrical purposes. Moreover, these weepers may discharge water found in the air cavity between the building's façade material and the core structure. These weepers may also serve as fresh air intakes and exhaust vents for mechanical ductwork and equipment, as engineered in any mechanical design.

Additionally, these weepers 9400 at their various locations may be engineered to have through channels or voids or plenums behind them that will cut entirely through the building from one end to another in an effort to guide wind through the building. This design intent is to make the building more aerodynamic and lessen the wind lateral load on the building, while not creating lift or easing wind resistance, as the entire building as a whole will be substantially lighter as compared to a conventional building using conventional construction methods and materials.

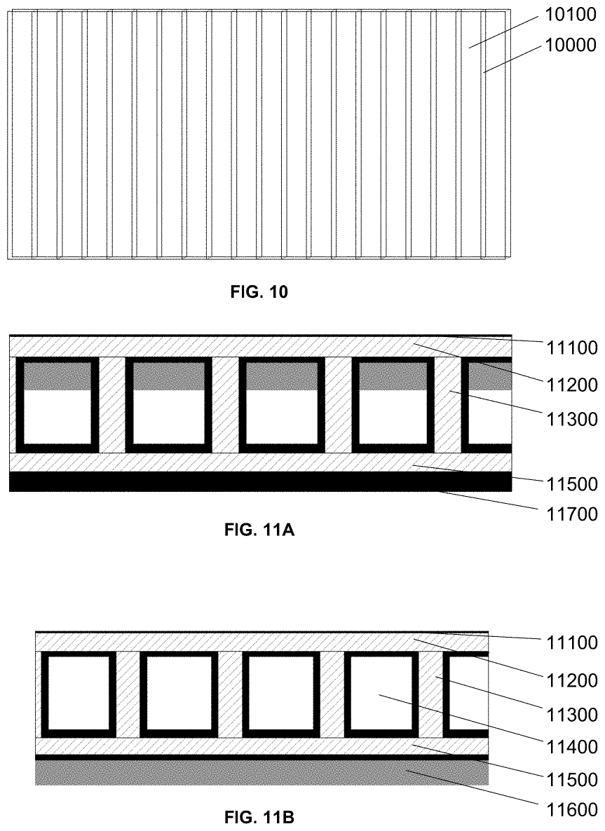

FIG. 10 illustrates a perspective view of typical wall and floor construction. CNT/graphene or HCML wall or floor system construction may consist of CNT/graphene or HCML “fins” or standoffs 10000 to support laminating layers of finished CNT/graphene or HCML sheet. This allows chases or routes 10100 within the building's structure for mechanical integrated rough-in components. Sizing and spacing of 1-5 ply CNT/graphene or HCML fins or standoffs may be calculated depending on the live or dead or shearing loads expected.

FIG. 11A illustrates a typical perimeter wall or floor construction cross section, where insulation is required. The wall or floor may consist of a thin layer of structural epoxy 11100 on exterior side of CNT/graphene or HCML structure, a single to 5 ply fabricated CNT/graphene or HCML structural wall system 11200 with epoxy waterproofing coating on exterior façade side, CNT/graphene or HCML material “fins” or standoffs 11300, boron nitride used as thermal insulation 11400 a second single to 5 ply 1 fabricated CNT/graphene or HCML structural wall 11500, and a structural epoxy coating 11600 used as a redundant electrical and magnetic field insulator on the interior side of the wall and finished as a seamless and uniform drywall coating ready for paint. The thickness of the boron nitride coating to be determined based on the total efficiency of the building as well as the heat gain and loss calculations in order to determine the specified insulating R-Value at that specific area in the building envelope.

FIG. 11B illustrates an example ceiling or floor system cross section where fire separation is required. The system would include a single to 5 ply fabricated CNT/graphene or HCML material wall system 11200, with epoxy waterproofing coating on exterior façade side 11100, CNT/graphene or HCML material “fins” or standoffs 11300 to support laminating layer of finished CNT/graphene or HCML sheet on both interior and exterior sides of the wall assembly, a second single to 5 ply fabricated CNT/graphene or HCML material wall system 11500 to sandwich the fins, and a boron nitride coating 11700 to act as fireproofing/fire retardant material, electrical and R-value insulation as well as the finished drywall product ready for paint. The boron nitride coating may cure uniformly, to provide a seamless surface. The system may also include a structural epoxy coating to serve as a redundant air and vapor and water barrier.

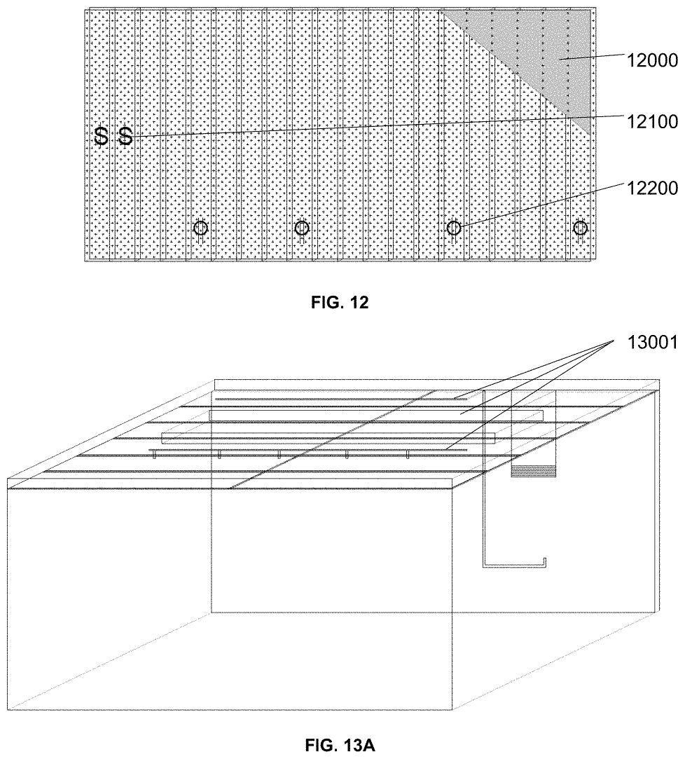

FIG. 12 illustrates a schematic view of a wall or floor system in typical wall and floor construction. The system may include a boron nitride and or epoxy top coating 12000 on the CNT/graphene or HCML wall system. The entire wall system framing behind the top insulating coat, where there are no plumbing pipes and components, will be electrified or roughed-in to accept all electrical finishes and fixtures.

Battery packs, such as in a below grade mechanical room, may serve as the entire building's uninterrupted energy source, including the battery pack's instrumental role in making the structural CNT/graphene or HCML system tensioned. Battery packs serve as the primary electrical source for the building, while having the redundant back-up of the city's electrical grid. In the event of a power outage, the battery system (ie. 1MW total capacity) may go into a conservation state only allowing bare necessity or life safety electrical dependent equipment and fixtures to operate.

In some embodiments, the addition of interior wall systems can be performed using conventional wood or steel stud systems and drywall by anchoring top and bottom tracks to the topcoat layer of epoxy/boron nitride. However, any structural work that requires anchoring into a building's structure may have to be performed by certified contractors trained to work with this building system and who are knowledgeable on how to break away and reinstate structural epoxy and or boron nitride. This is in order to tap into the CNT/graphene or HCML material or expose the building's integrated plumbing, HVAC and electrical component rough-ins. This may be mandatory as the electrical current running through superconducting CNT/graphene or HCML core may have to be isolated before any exposure work can commence. Furthermore, any remedial work to the structural system may have to be reinstated to the designer's design standards and tolerances. If a certified contractor is hired to perform such work, any new wall system alterations may be completed with the building's native material.

FIG. 12 also illustrates light switch devices 12100 and duplex receptacles 12200. New industry standard devices may need to be created for this building system. For example, devices may need to have built-in transformers to step up and down the building's power to the required amperage and voltage for each fixture. Devices may also need to house built-in insulators and gaskets for vapor barriers. In some embodiments, prongs on new devices may directly penetrate epoxy or boron nitride coating on CNT/graphene or HCML structure, and the CNT/graphene or HCML material may also serve as a reinforcing substrate for the devices or fixtures to be mounted to. Electrical contractors responsible for cutting into epoxy or boron nitride coating to expose mounting points may need to use specialized tools and may require training.

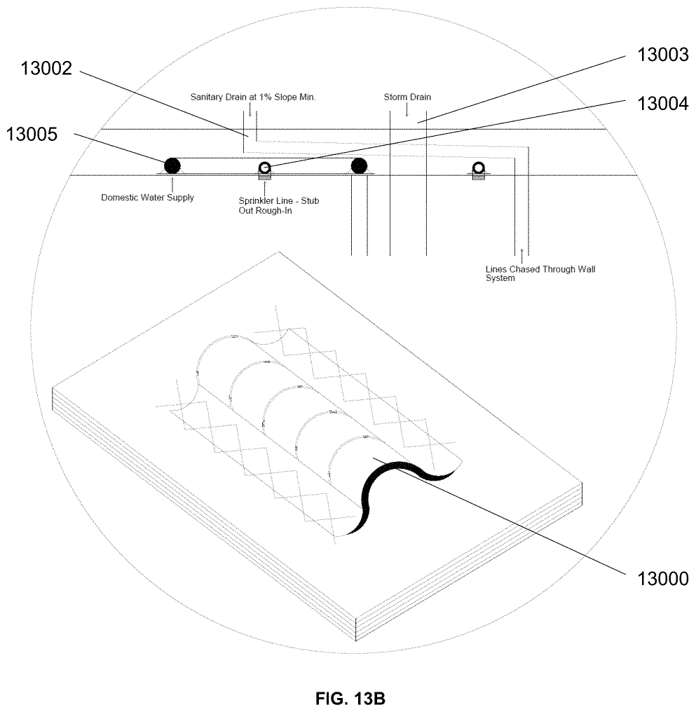

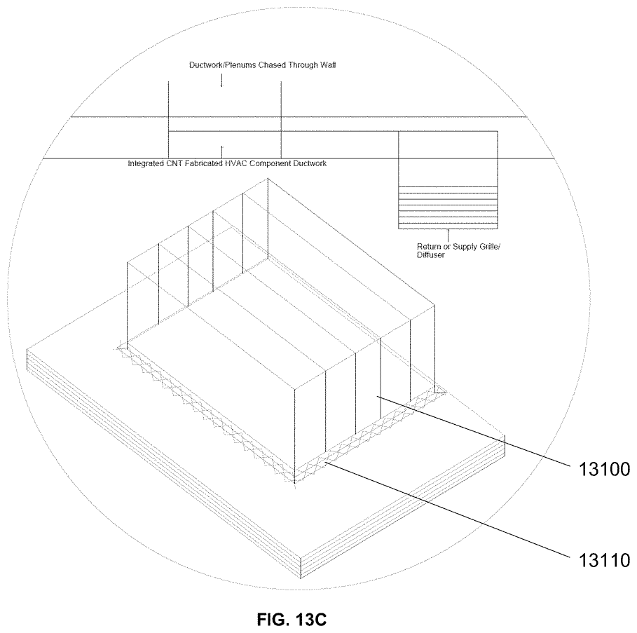

FIG. 13A provides a sectional and schematic illustration of mechanical and electrical rough-in integration 13001 in a CNT/graphene or HCML construction system, showing an example wall to ceiling assembly. An epoxy coating on CNT/graphene or HCML structure may act as the finished product on the roof without the need for any built-up bitumen membrane and or tar finishers, as epoxy may be water resistant and may be without seams as a result of how it was applied during the manufacturing and construction phases.

FIG. 13B shows details of plumbing integration. Integrated CNT/graphene or HCML plumbing components may be placed within ceiling or roof or floor plenums. Bulkheads can be manufactured to enclose mechanical rough-ins rather than creating an entire floor or ceiling or roof plenum. For example, bulkheads may include sanitary drains 13002, storm drains 13003, sprinkler lines 13004, and domestic water supplies 13005.

For example, fresh water supply lines, sanitary and storm drains and sprinkler lines may be integrated within the CNT/graphene or HCML structure and chased through the wall cavities routed towards their respective mechanical fixture locations. Rough-in destinations may be ready to accept valves/finishes/fixtures by finishing contractor as sprinkler and plumbing lines will be stubbed out of ceilings and or walls. Fasteners may be mechanically pressure fitted with “0” rings or gaskets. Threading of finished fixtures can be an option. As a safety measure, building's electrical current may not pass through these plumbing rough-in components once the erection of the structure is completed. Boron nitride and epoxy, as a countermeasure, may act as an electrical insulator should any electricity be live in these components. In embodiments, switching off the building's electrical energy that runs through structure may be achievable via remotely placed and controlled resistors and relays.

A building's mechanical components may be integrated at the manufacturing phase. For example, ribbed CNT/graphene or HCML material formed into an exoskeleton 13000 may create form for the plumbing or sprinkler lines and drains. Rib intervals and frequency or pattern may be calculated based on PSI requirement of each individual system and structural resistance needed. Manufactured plumbing or sprinkler components may be stitched to the building's CNT/graphene or HCML substructure with outer shell covered with the same impermeable boron nitride coating or epoxy coating as the rest of the CNT/graphene or HCML sheets, which may be sprayed on in manufacturing. In embodiments, environmentally friendly and non-toxic epoxy coating may be sprayed onto inner parts of plumbing components for domestic and sanitary lines.

FIG. 13C illustrates HVAC integration. CNT/graphene or HCML HVAC material components may be integrated within ceiling or roof or floor plenums. In addition, bulkheads can be manufactured to enclose mechanical rough-ins rather than creating an entire floor, ceiling or roof plenum.

Manufactured HVAC ductwork components may be stitched to the building's CNT/graphene or HCML substructure, such as with stitching 13110, with the outer shell covered with the same impermeable boron nitride coating (where insulating ductwork is required) or epoxy coating as the rest of the CNT/graphene or HCML material, which may be sprayed on in manufacturing. Ductwork 13100 or full ceiling or floor plenums may be sized in accordance to how many CFMs may be needed for supply and return air; based on the criteria and sizing of each room, distance from main duct branch or equipment, etc.

In some embodiments, cooling of superconducting composite material will be required to keep the laminar system at its critical operating temperature in order to experience zero electrical resistance. A cryogenic system will be installed in a building's or structure's mechanical room and pump liquid nitrogen into the manufactured laminar material (material option 1 or material option 2). This is if room temperature superconductivity cannot be achieved in the CNT/graphene or HCML material.

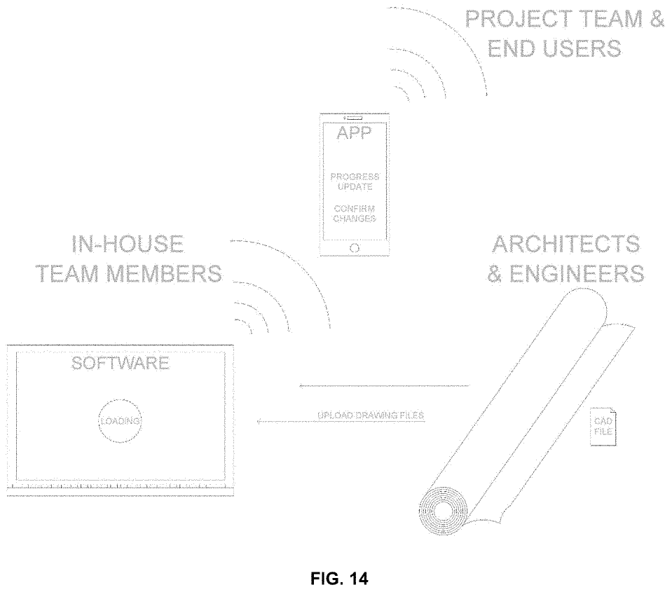

As illustrated in FIG. 14, in some embodiments, software may be integrated to allow further interaction with the CNT/graphene or HCML structure. Architects, designers, and engineers may be able to upload their plans to the software.

In some embodiments the software will deconstruct every component of a conventional building system as designed by the architects or engineers against what is permitted and allowed within the construction tolerances of this new building system material and construction approach. Once the software reviews the drawings it will then populate the design information into the system hub and create the working drawings ready for permit and construction based on this system. During the review process the software will also provide the architects, designers and engineers with recommendations should any changes need to be made. An app can be created to work with the software, providing live updates on the processes, changes, and recommendations to internal personnel working on the specific project and end users. The app may also carry over to the manufacturing and construction stages, providing all team members with live updates on progress and providing manufacturing and construction control to managing team members.

Software may also include a building automation system, BAC/BAS, that controls, monitors and updates the various components and equipment of the building back to a control station. For example, it may control the heating and cooling equipment, make-up air units, air handlers, lights, annunciator panels, pull stations, elevators, thermostats, diffusers, fire dampers, compressors, fire exit signs and other lighting, auxiliary components, security systems, electric strikes and mag-locks, card readers, auto operators, fire alarm, smoke detectors, charging stations etc. This software may also integrate an AI (artificial intelligence) component that can learn about the building, its occupants and its surrounding environment in order to intelligently make recommendations and suggestions as it sees fit, and adapt to changing environments and equipment added or changed during the lifecycle of the building. In some embodiments this may be 3rd party integration software. In some embodiments, software can be updated over-the-air.

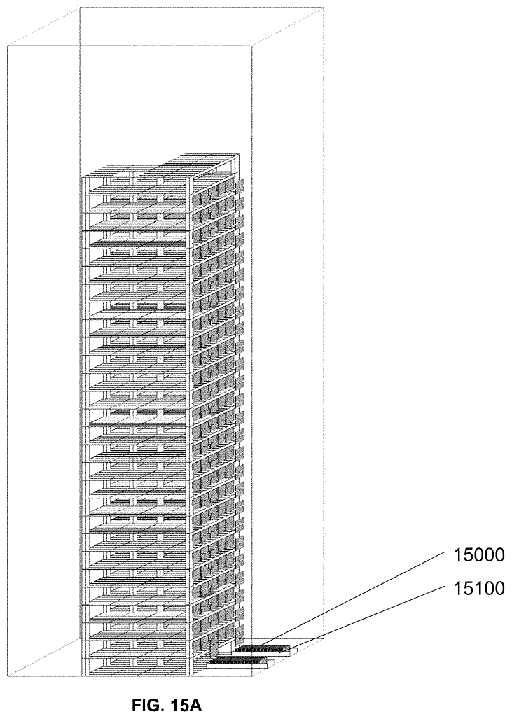

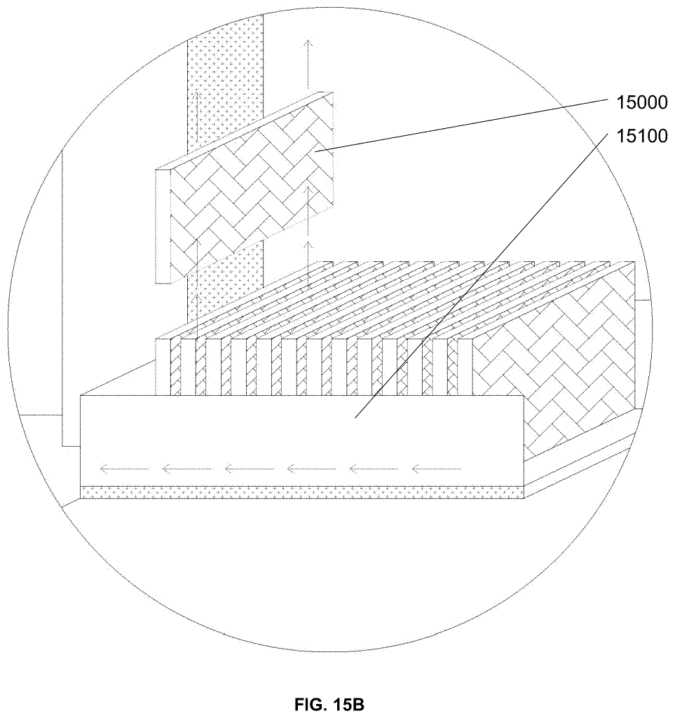

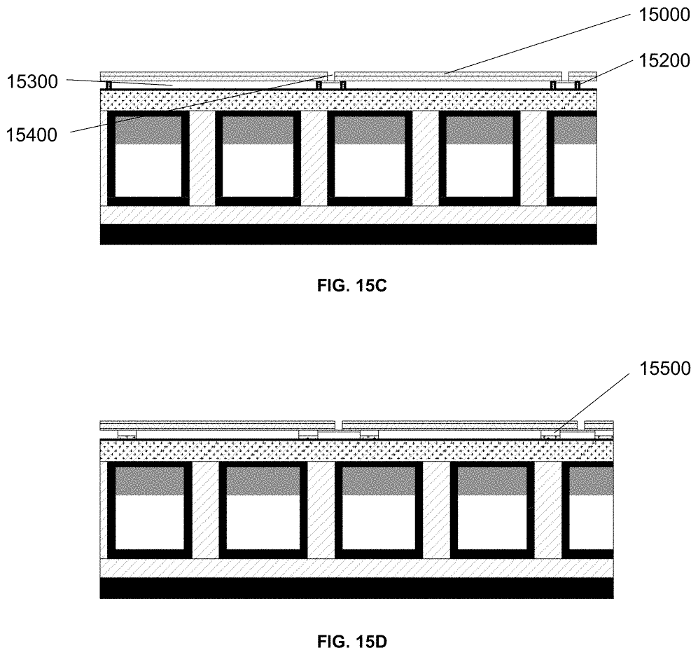

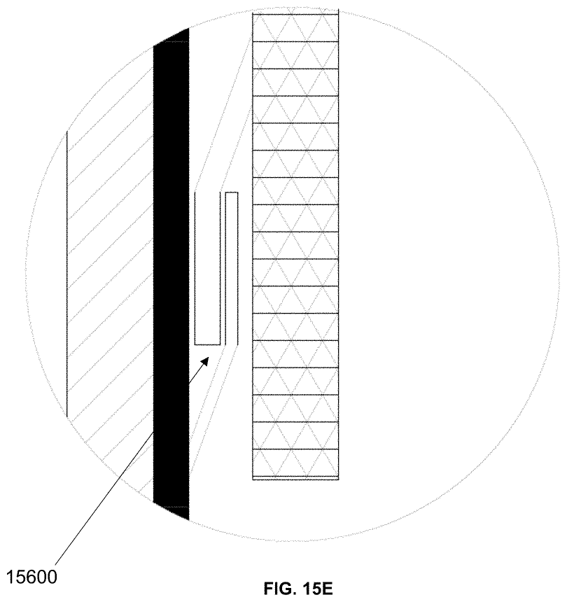

As illustrated in FIG. 15A, in some embodiments, the rollout of building façade may be automated. Shipment of lightweight building façade slabs 15000 may be made to a construction site on battery or electrically operated skids or frames 15100. These slabs may be made to resemble actual stone material, aluminum, metal, concrete, wood, rubber, plastic cladding etc., for example, with a thin veneer layer laminated to a lightweight structural core. Examples of the lightweight structural core of the façade slabs could be fiberglass, CNT/graphene or HCML, lightweight metal alloys etc. This may be similar to the way in which porcelain slabs can be made to look like marble.

In some embodiments, slabs may be designed and engineered to have fixed permanent magnets on their unfinished backs to be used to create an electrical or magnetic field connection with the electromagnetic building structure. In some embodiments, these magnets may lift the slabs off the skids or frames and move the cladding along the building's exterior plane and into place via a hovering propulsion system. This may be accomplished and regulated by the building's electromagnetic core structure, with strategically placed and controlled magnetic fields activated by alternating currents. Built-in resistors or relays in the CNT/graphene or HCML core structure of the façade slabs, controlled wirelessly or through the base building's automation system, may further assist in guiding or propelling the exterior cladding into place.

As illustrated in FIG. 15B, façade slabs 15000 with built-in fixed permanent magnets may be shipped to the site and placed in skids 15100. Skids or hoppers 15100 may be designed with built-in electrical conveyor or magnetic floors that move the units in sequence as the slabs are drawn towards the electromagnetic CNT/graphene or HCML core structure and propelled into place through the use of controlled magnetic fields along the building's plane. All of this automation may be controlled off-site remotely using software or apps by sending programmed secured radio-wave frequency signals to the CNT/graphene or HCML structure that control the various relays, transistors, resistors and transformers built into the structure. Multiple slabs may be lifted onto the face of the building to expedite installation of the façade. The software controlling the positioning of the slabs will identify where all the slabs are located at any given point on the building, through the use of proximity sensors built in.

Once the façade slabs are at their designated areas, there may be several options to fix the slab into the building's structure. For example, they may be fixed via a mechanical cleat built into the CNT/graphene or HCML structure.

As illustrated in FIG. 15C, façade slabs may also or alternatively be fixed by using the building's exterior epoxy coating activated by electricity and a chemical reaction from the special epoxy coating on the slabs. For example, the cured thin layer of exterior epoxy on the CNT/graphene or HCML structure may be reactivated by a melting process at specific spots behind each individual slab to serve as the mounting points. To accomplish this, built in transformers, in the CNT/graphene or HCML structure may surge through the system and step up the building's electricity significantly at these points in order to melt the epoxy via thermal transmission. Thus, making the electromagnet CNT/graphene or HCML structure essentially a controllable microchip with the use of built-in transformers and resistors or relays in order to control the electromagnet for purposes of self-building construction assembly and automation and in the future, such as by moving interactive exterior cladding components.

For example, the structure may include CNT/graphene or HCML stand-offs 15200 coated in insulated and waterproofed boron nitride built into the structure during manufacturing. Façade slabs may be ‘hovered’ into place alongside the buildings face and maneuvered into place remotely. Once material is at a designated location a greater magnetic field may be created to attract the cladding to the core CNT/graphene or HCML structure to make contact, at which point the re-melting of the epoxy on the CNT/graphene or HCML structure begins to the point of malleability. A chemical reaction may then occur between the structure's coating and the coating on the façade slab, which may be due to a surge of electricity at the mounting points; the surge to create the greater magnetic field of attraction and to induce heat transmission. This may be completed by the transformers built into the CNT structural core. The chemical reaction may resemble properties found in contact cement. The use of a thin epoxy coating on the exterior of the CNT/graphene or HCML structure may enable a magnetic field to more easily transmit through, which may be useful at various points such as when maneuvering façade cladding into place.

As illustrated, air space 15300 may be included behind cladding as in conventional construction, used to discharge any water that penetrates the building envelope, such as through the non-structural CNT weepers 15400 strategically placed behind the cladding. The weepers connected to the air space serve several purposes, for example to discharge any water found behind the cladding and to capture carbon dioxide found in the air as research has shown.

As illustrated, exposed non-epoxy coated, non-structural CNT/graphene or HCML weepers may be located throughout the building envelope system.

In embodiments, exterior window treatments and curtain wall system may be installed in the same fashion as cladding, with the exception that when each unit is in place and in its fixed position, caulking that is around the unit may chemically react to exterior epoxy coating found on the CNT/graphene or HCML core structure, expand and cure with the heat transmission from the electromagnetic system, therefore sealing the unit. This process may be the same for any venting louvres and any other exterior fixture that requires caulking as the sealant.

However, construction of the exterior cladding may, in some embodiments, be performed with conventional construction methods, such as using cladding materials bearing down on the ledge of the foundation wall with mortar joints throughout (if req'd) and mechanical fasteners into the buildings substrate structure. In such embodiments, the mechanical fasteners to not penetrate passed epoxy coating into the CNT/graphene or HCML material. If fasteners require greater support, fasteners can anchor to CNT/graphene or HCML material using specialized anchors as to not disrupt flow of electricity through the CNT/graphene or HCML structural sheets and to also insulate the fasteners and in turn the cladding material from electricity, and so that it is water and air tight and isolated. This may allow for any water penetration through the building's exterior façade to drain through the air cavity behind cladding and discharge through the CNT/graphene or HCML weepers.

As illustrated in FIGS. 15D and 15E, mechanical fasteners 15500 may be built into the exterior slabs as well as in the CNT/graphene or HCML structure at the manufacturing level. This may be in lieu of utilizing epoxy as the fastening agent. Mechanical fasteners may be a cleat system 15600 and have the slabs hang from the structure rather than fixed in place.

In embodiments, all life safety and building monitoring sensors such as heat sensors, smoke or carbon monoxide sensors, natural gas sensors, water sensors, pressure sensors, load sensors etc. may be built into CNT/graphene or HCML material core structure and constantly update data information to the BAS/BAC system.

In embodiments using AI, the BAS/BAC software system may constantly monitor and detect and recalculate live and dead loads bearing down on the structure in order to determine if loads are within the designed tolerances of the structure. This function may be particularly important where the building has the potential to transform different components. For example, a building material or assembly that was once in a fixed position on a substrate could now be cantilevered, or a cantilevered building material or assembly may now have a greater cantilever projection. Thus, changing the load calculations, torsion/torque forces and parameters.

EMF/EMI & heat shielding solution may stay in place during the process of adding cladding, until cladding install has been completed. The cladding may then serve as an EMF/EMI solution.

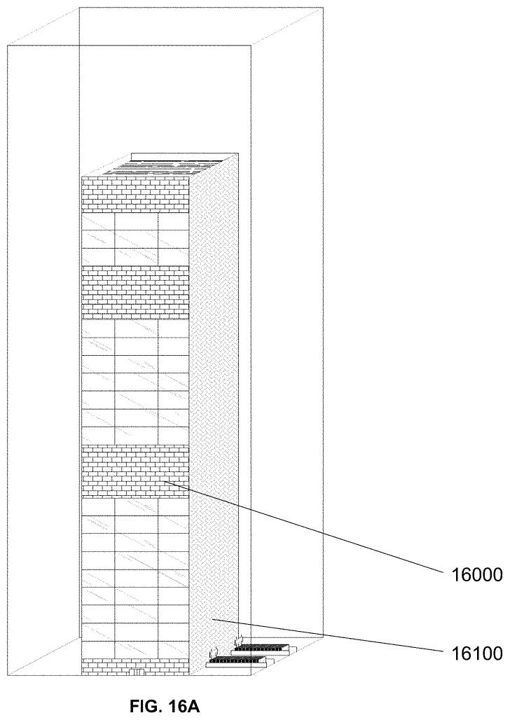

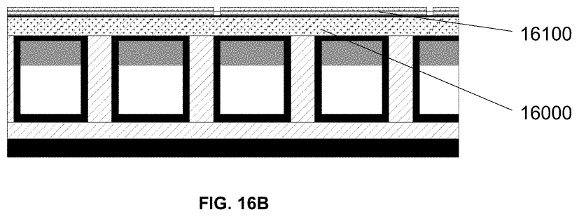

FIG. 16A illustrates another way of integrating cladding. Specially made textured epoxy coating 16100 on the exterior building shell of the CNT/graphene or HCML structure 16000 may be sprayed on CNT/graphene or HCML material in manufacturing, and may have limestone, marble, clay pigmented powder embedded in material and made to resemble actual stone, concrete, marble, steel, rubber, clay when heat treated and cured from the heat transmission of the electromagnetic CNT/graphene or HCML structure. Different shapes and details such as chamfered edges created from the CNT/graphene or HCML core structure may essentially be used as a substrate for the finished epoxy finish to take on its form. Curtain wall system and other exterior cladding fixtures such as mechanical louvres to be installed as described above.

EMF/EMI and heat shielding solution may stay in place during this process of construction until cladding install has been completed. Cladding may then serve as an EMF/EMI solution.

FIG. 16B illustrates an exterior perimeter wall façade cross-section, where epoxy 16100 is ‘grown’ as cladding. As set out above, the specially formulated textured or pigmented epoxy coating 16100 on the exterior side of CNT/graphene or HCML core structure 16000 will act as cladding. Epoxy sprayed onto structural sheets at manufacturing level and additive powders/aggregates will be infused with the epoxy to resemble limestone, clay, rubber plastic, aluminum, bricks, marble, steel, zinc, faux wood, brass etc., when fully and uniformly cured during the heat treatment process performed by the heat transmission emitted by the electromagnetic core structure. The end shape and form of the epoxy, when cured, may take on the substrate form of the CNT/graphene or HCML structure. During the process, the site may maintain shielding to avoid airborne dust so that it does not interfere with the finished product/look.

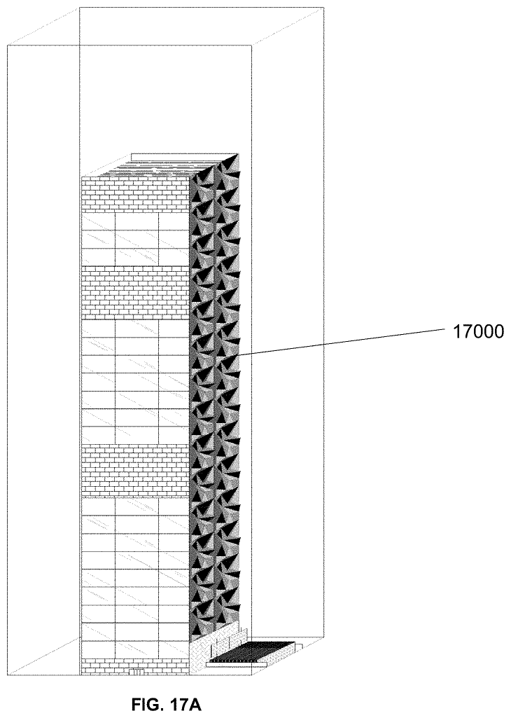

As illustrated in FIG. 17A, façade slabs 17000 may also be made of small pieces 17100, as depicted in FIG. 17B, mechanically and flexibly connected to one another to allow a changeable façade. As before, shipment of lightweight building façade slabs may be made to the site on battery or electrically operated skids or frames 17200 and may look and be placed as described above.

This version of the exterior façade cladding may be interactive in the sense that the make-up construction of the slabs may have individual isolated tiles attached, such as by a pin type system to one another, and can pivot relative to one another, such as on their hinges. For example, the mechanical movement of each tile may be accomplished through the harnessing of wind energy (more prominent at higher altitudes) and aided by small magnetic pulses performed by the building's intelligent electromagnetic core activated when it senses that the exterior tile material is in its movement cycle.

Such an interactive exterior cladding may serve an aesthetic purpose but may also regenerate electricity to auxiliary components and equipment within the building and or low consumption electrical fixtures such as lighting, receptacles etc. and integrated screens. Thus, converting the kinetic energy to usable electricity. This regenerative process or cycle may work in tandem with solar roof panels or tiles or other equipment.

In some embodiments, when individual tiles are in their active state and in motion, a programmable lighting sequence may occur with optionally installed LED strip lighting behind tiles/slabs. Intelligent lighting sequencing as well as façade movements, and later on building transformation, may be incorporated in part to create a new interactive design language and an emotional connection between the building and the outside environment.

As illustrated in FIG. 17B, lightweight slabs or sheets 17000 may be made up of individual connecting tiles 17100 through the use of pivoting pin connectors. Each tile component 17100 may have their own built-in fixed permanent magnet so that its potential movement through the harnessing of the wind can be aided by the building's electromagnet core. Tiles or slabs or sheets may be aerodynamically designed in order to efficiently harness wind energy. Slabs or sheets may be strategically placed on the building's exterior in order to maximize its intended purpose.

Where slabs are anchored or fastened to the building's core structure via epoxy or a mechanical cleat system, mounting points may be in locations so as to not disrupt the mechanically independent moving tiles. In some embodiments, shapes of exterior interactive moving cladding may take on a wide array of forms based on how tiles are cut and pin connections, or other connections, are connected to their adjoining tiles.

In some embodiments, different shapes & backlighting may change and be controlled with over-the-air updates to the BAS/BAC system. Providing the building with a multitude of different aesthetic appearances that can be achieved with the live/interactive walls. Ultimately providing the building and its architecture the ability to transform its overall appearance or shape wirelessly as time goes on. Adapting and staying current with the times.

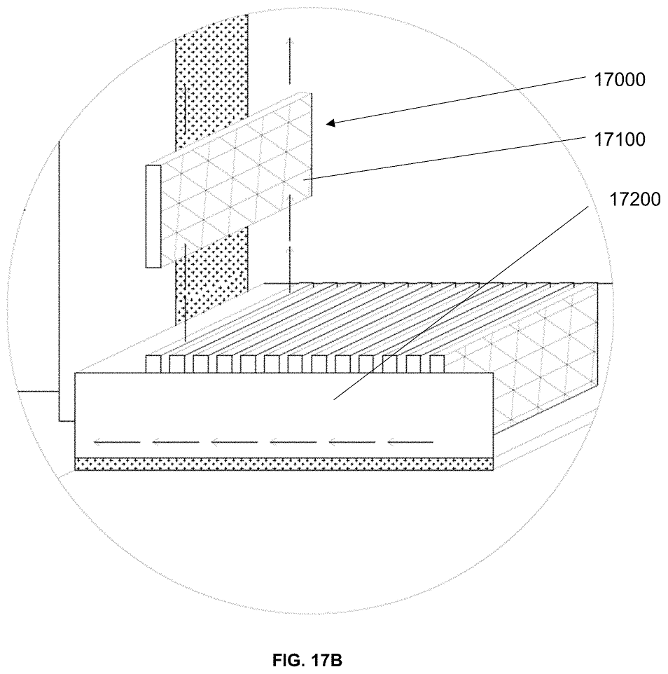

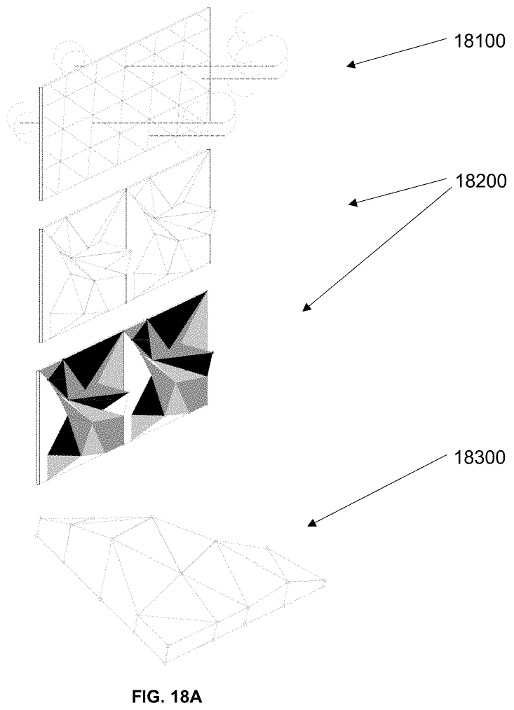

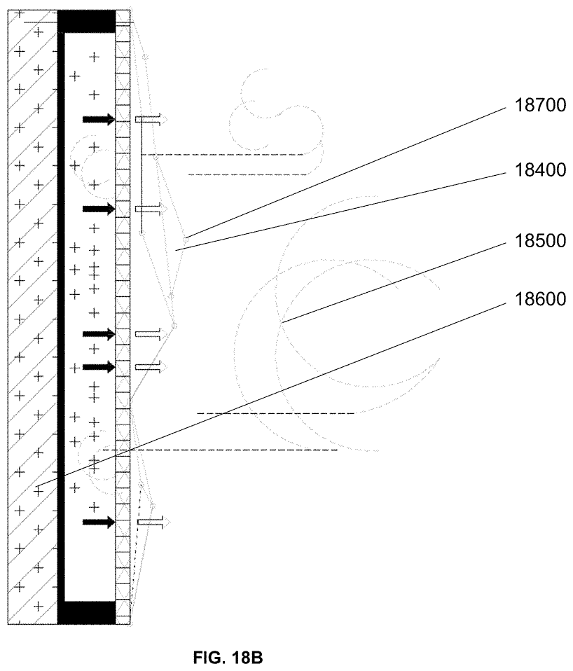

Further details of the interactive façade material are illustrated in FIGS. 18A to 18C.

FIG. 18A illustrates cladding material in sheet or slab form made up of triangulated shapes. First in a relaxed or dormant state 18100 with independent free moving pin connections 18700 located at each individual tile, and wind energy to freely move through tiles via spatial void channels designed around each connection point or through perforations in the tiles; which may be needed so that the wind can reach the building's core or the air space behind the cladding material to create lift and initiate the mechanical movement. FIG. 18A next illustrates cladding material composed of geometric tiles in their active state 18200 through the harnessing of wind energy aided by magnets. FIG. 18A finally illustrates an example of a different possible geometric shapes 18300 that can be achieved in some embodiments.

FIG. 18B illustrates a cross section of the interactive façade material according to an embodiment. The intelligent electromagnetic CNT/graphene or HCML core structure sends a pulse of electrical current when exterior interactive tiles 18400 are in motion from the harnessing of wind energy 18500. This may aid in the repulsion of each individual tile away from the core 18600 via an opposing magnetic field and to ensure tile is at its maximum potential (distance) away from the core so that when it settles back to its natural inactive state the kinetic mechanical momentum of this cycle will put electricity back into core and the buildings battery packs. As illustrated, the mounting connection for interactive exterior cladding tiles or slabs or sheets may either be completed by an epoxy connection or by a mechanical cleat fastener. The opposing magnetic field to the charged individual tiles may be activated when it senses tiles are in motion through the use of a proximity sensor.

As illustrated, the exterior interactive tile sheet or slab system at full momentum when connected to each other through a pin system may allow pivoting movement and extensions. This may be designed aerodynamically and using lightweight material so that the façade can absorb the maximum wind energy potential in this area of construction. Wind energy may move through manufactured void channels, slots or perforations found in the exterior cladding material; passes through the building envelope and creates lift behind tiles. The tiles may be thus moved between a lifted and more relaxed state or inactive state.

FIG. 18C is a perspective view of an embodiment of interactive cladding wall tiles 18800 in their active or ‘live’ state as wind passes through the building's envelope, agitates the individual tiles while the building's electromagnetic core structure detects the movement and sends a small electrical current at these locations to aid in the repulsion of the tiles away from the core structure. As the tiles 18800 move back to their original non-active state, it is at this point that the interactive live tiles put electrical energy back into the building's core. This is similar to the way regenerative braking found in electric or hybrid vehicles gathers energy. The accumulated electrical energy will be used to recharge the building's battery packs and provide electricity for low electrical consumption fixtures within the building and the integrated screens (See Future Adaptation Version 3.1). This regeneration process to auxiliary components/battery packs to work concurrently with 3rd party solar roof panels/tiles should the design call for this type of energy storage.

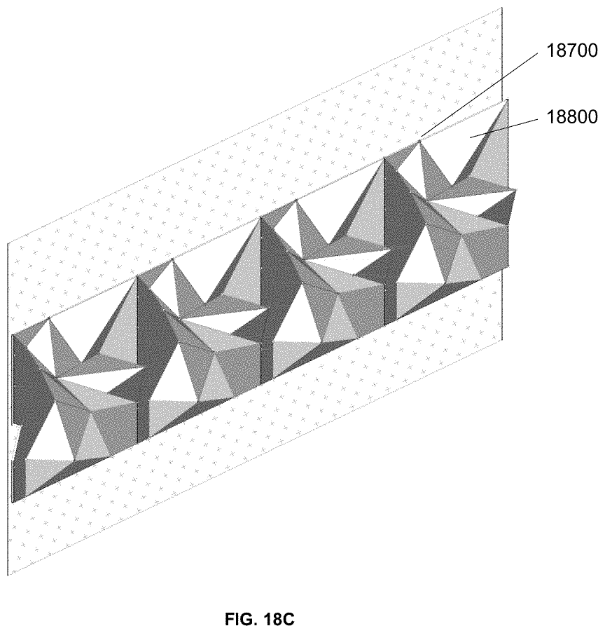

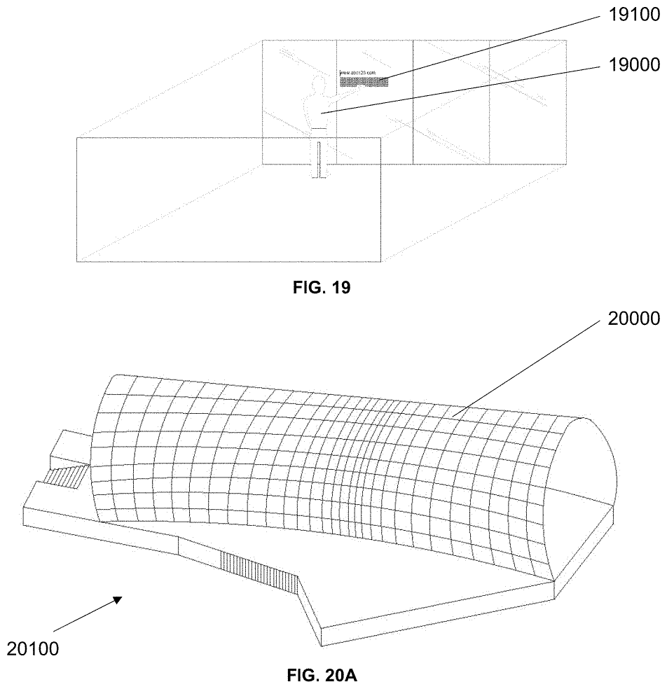

As illustrated in FIG. 19, users, such as designers, owners, engineers, or occupants, 19000 may interact with components of the building, software, and interactive cladding. For example, interior wall coatings may be used which are clear coatings 19100, able to transmit or project images as found in smartphone, computer and tv screens. Such coatings may be epoxy coatings or may be other coatings and may replace sections of epoxy coatings. Such coatings may cure and harden in a uniform seamless manner just as the other epoxy and boron nitride coatings, such as through the use of thermal transmission during the building erection and curing stage of construction. Again, construction may need to ensure that the site is free from dust.

In some embodiments, clear coatings may be applied only in designated areas as per design, as coating may not have the same structural integrity as found in the 2-Stage epoxy coating. The CNT/graphene or HCML core, at these integrated screen locations, may have the computing internals as found on smartphones and computers alike and integrated during the manufacturing process. This may make these interior walls computer touchscreens, where occupants can interact with the building's ‘live walls’ to watch TV, perform computer tasks, access the internet as well as control base building components ie. blinds, garage doors, light fixtures, fans, thermostats etc.

In some embodiments, the building will also introduce induction or wireless charging induction plates at parking garage locations for EV vehicles, and occupants can interact with their vehicles whilst connected, perform updates on their vehicles and check on their charging status through these integrated computer screens. These designated computer screen locations will also allow for live wireless updates over the internet to their operating systems as well as updates to downloaded apps and to the BAS/BAC.

In some embodiments, live walls may be able to diagnose and rectify any issues related to the BAS/BAC systems, as well as construction components or equipment during the constant scanning of the building. This may be made possible via AI software in some embodiments, to constantly, in real-time, monitor building components, intelligent battery pack system and live/dead loads to determine if building is within the allowable tolerances as specified by the CNT/graphene or HCML core structure.

In some embodiments, the system may utilize windowpane or curtain wall systems as computer screen canvases.

In some embodiments, similar constructed buildings of this technology will have the ability to ‘communicate’ with one another. This may be particularly useful for wireless charging.

As illustrated in FIGS. 20A to 20C, in embodiments, through the use of the electromagnetic core and electricity alone, areas or sections of the building will have the ability to move or transform in shape using the batteries, such as using a ‘boost function’ extracted from the battery reserves. This battery boost function along with the built-in transformers, amplifiers will concentrate more electricity to designated areas of choice as designed by the architects. Enabling sections of the building to be lifted, moved and or transform in shape. Having the CNT/graphene or HCML core essentially acting as a potential pneumatic actuator. Made possible with future material science advances in the CNT/graphene or HCML materials. Providing more of a less dense elastic aerogel composition while maintaining the necessary designed structural requirements. This adaptation further expands and is an evolution of version 3.0's iteration (See FIG. 17A) but rather than harnessing wind energy it utilizes the building's strong electrical and magnetic field potential. In such embodiments, the building uses the building's strong electrical energy potential, since batteries may have been designed to, at minimum, erect the total dead weight of the building structure.

In some embodiments, a building's battery boost function could also be utilized for moving heavy equipment within the building system as opposed to conventional hydraulic, pneumatic or pulley systems, such as elevators and escalators.

The controlling of this system may enable architects to look at architecture differently, as buildings and components can now be interactive in surrounding environments, take on new shapes, or change in look and be updated as time elapses.

Where CNT/graphene or HCML actuation components are expected to move, they may receive only Stage-1 of the epoxy coating. As described above, the first epoxy layer may possess elastic properties that are not possessed by the 2-Stage, or second, epoxy coating when fully cured. This may enable the CNT/graphene or HCML actuators to fully expand to its outer limitations or contract on command, as programmable by the BAS/BAC system; lifting or moving or reshaping segmented designed building components.

In some embodiments, CNT/graphene or HCML actuators may assist in permitting replacing exterior façade cladding and components with new or replacement panels and components. As illustrated in FIGS. 20A to 20C with respect to an amphitheater roof canopy structure 20000, CNT/graphene or HCML actuators may have the potential of reshaping purposefully designed segmented building components, such as exterior cladding, roof systems, curtain wall systems etc., when CNT/graphene or HCML core is in full actuation or articulation based on programmed settings and forms. For example, a roof structure 20000 may move from a dormant or inactive state 20100, to a stretched or pulled state 20200 utilizing the electromagnetic core to program forms or shapes.

In some embodiments, resizing and moving may involve repositioning segmented ‘tiles’ in different x, y z planes. The smaller the building's component tiles are, the more dramatic shapes may be achieved.

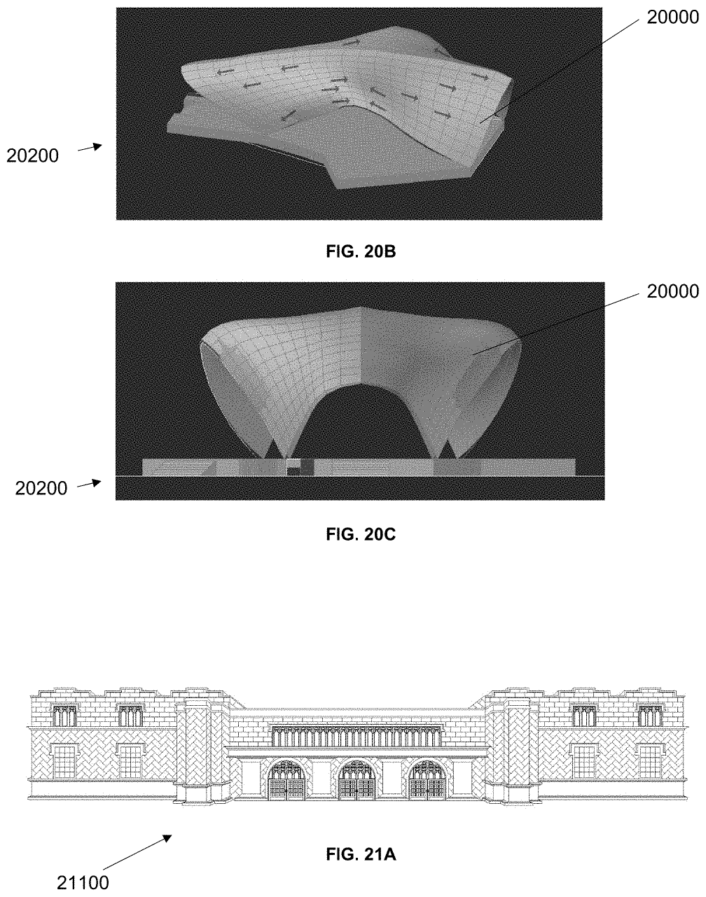

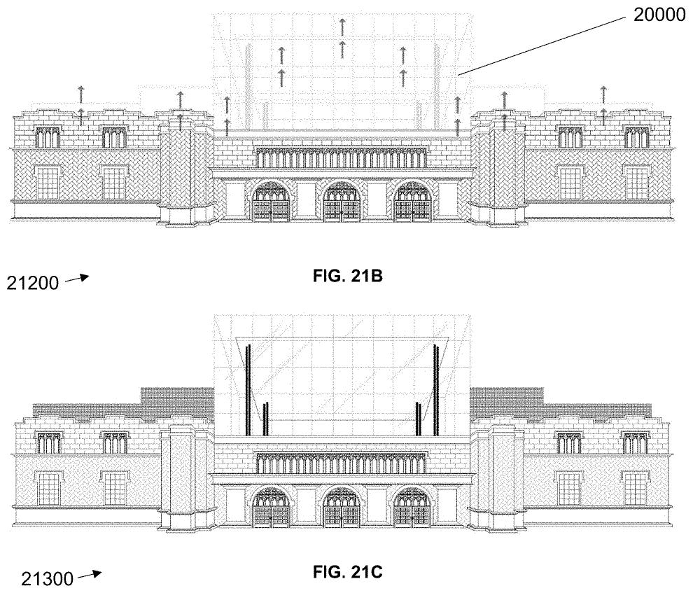

FIGS. 21A to 21C show an example use of CNT/graphene or HCML actuators in transforming a museum. An integrated CNT/graphene or HCML structure, in its active state, raises the roof 21000, such as to include new common areas, a rooftop terrace, higher ceilings or atrium, etc., including through the use of the segmented glazing. This can also be used to retrofit an existing building. For example, this may make available the ability to utilize the airspace above a building by the addition of floors. CNT/graphene or HCML actuators may transform a structure from its original form 21100, through actuated lifting 21200, to a larger structure 21300.

As illustrated in FIG. 22, wireless charging may also be integrated into a structure 22000 having interactive façade. In some embodiments, technology built into CNT/graphene or HCML core structure, such as at the onset of this building system material and construction approach, may be used to charge, such as wirelessly charging, batteries found in foundation's mechanical room as well as the electromagnetic or superconducting magnetic core under this iteration. This may allow more efficient electrical energy sourcing and may allow a transition off grid dependency. As battery technology advances, the components needed for wireless over-the-air electrical charging from a transmission tower may also be implemented in the manufactured or constructed design. As the CNT/graphene or HCML structural core may be a superconductor and supercapacitor, the building may also act as an energy source able to wirelessly charge interfacing devices and nearby buildings or structures or systems.

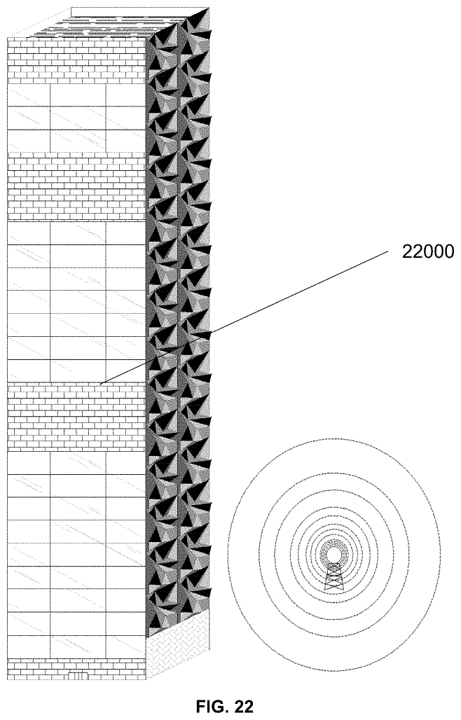

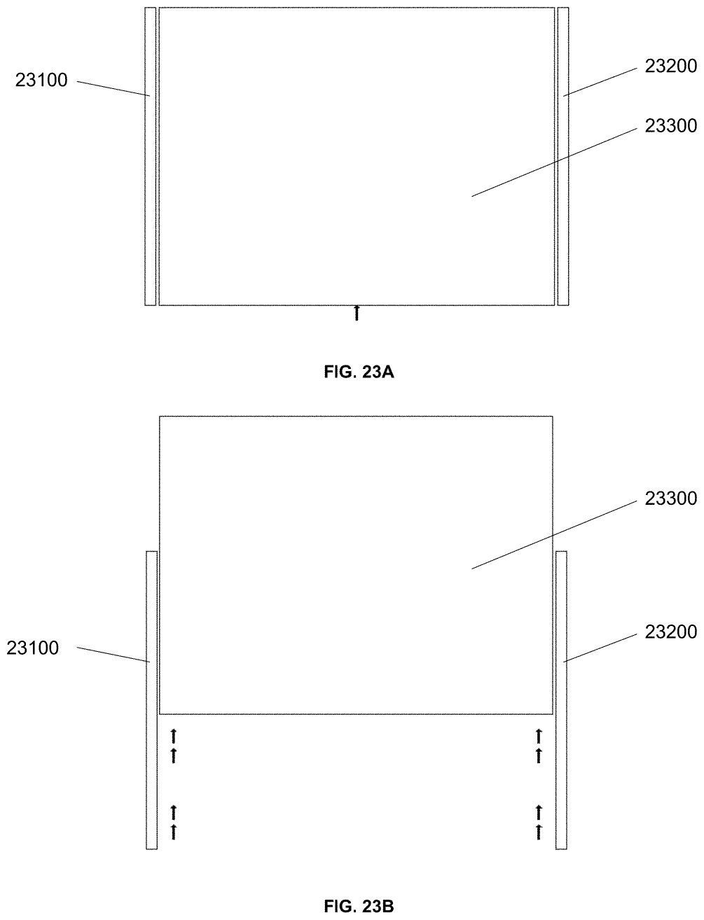

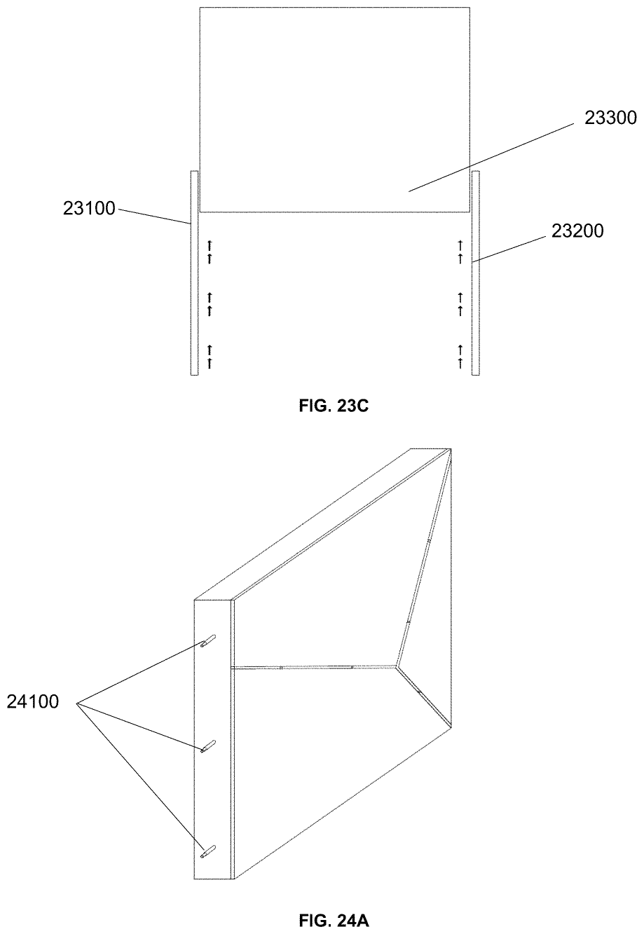

FIGS. 23A to 23C show a type of building component provided to allow movement. Stationary fixed CNT/graphene or HCML electromagnetic structural core components 23100 and 23200 may form a frame for a moving component. A moveable CNT/graphene or HCML component 23300 may be held in place by the electromagnet core and may be able to move on its vertical or horizontal axis by controllable CNT/graphene or HCML structure. This may be useful for elevator cabs, escalators, and as illustrated in FIGS. 21A to 21C, in transforming a building. An embodiment of a moveable portion is shown in an unactuated state in FIG. 23A, a partially activated state in FIG. 23B, and an activated state in FIG. 23C.

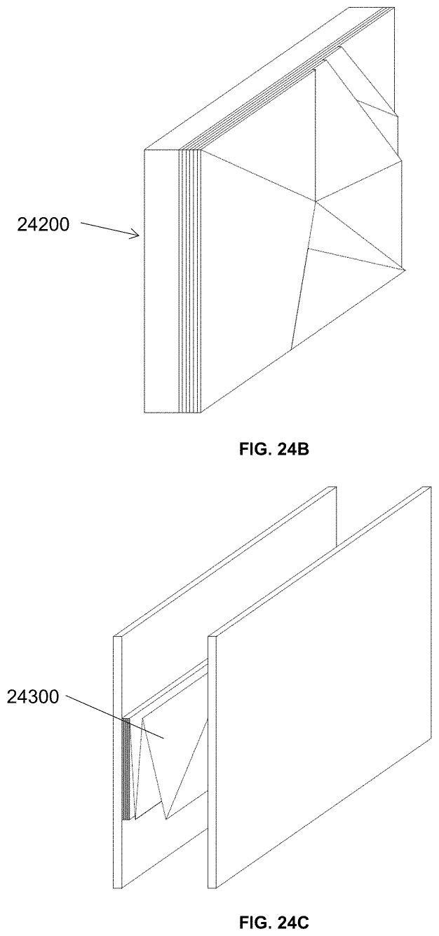

FIGS. 24A to 24C show segmented CNT/graphene or HCML structure with different types of actuators, which may be used where greater articulations are required. FIG. 24A shows a piston actuator, where miniature piston type CNT/graphene or HCML actuators 24100 are incorporated, such as during the manufacturing process, between the segmented CNT/graphene or HCML structure to allow for articulation and transformation. FIG. 24B shows a layering actuator 24200, where layered segmented CNT/graphene or HCML structure or building components are held by the electromagnetic core, and able to be manipulated into different shapes and move freely along a surface plane area. FIG. 24C shows an accordion actuator, where accordion style CNT/graphene or HCML material 24300 is incorporated, such as during the manufacturing process, between the segmented CNT/graphene or HCML structure to allow for articulation and transformations.

In some embodiments, any new building or structure constructed using this technology that requires demolition will undergo a recycling program that will reverse the erection process leaving an inactive ‘deflated’ CNT/graphene or HCML sheet core. Such a process may include a series of redundant safety measures built into the structure during construction that will not permit any outside forces and or acts of nature to tamper or compromise the structural integrity of the structure. For example, a sequential process cross referenced to a master safety plan checklist may be required to ‘deflate’ or demolish the structure. Once exterior cladding has been stripped and the CNT/graphene or HCML sheet structure is back to its original state, the material may be stripped and recycled for future manufacturing.

The embodiments disclosed herein are not specific to the construction industry and can be used in different industries as an across-platform technology. For example, as mentioned above, the materials and techniques disclosed herein may be used in the construction of consumer device, land or air vehicles and components, infrastructure and civil construction such as roads, railroads, aqueducts, tunnels, sewers, high tension towers, bridges etc., robotics, artificial limb and prosthetics, etc.

What is claimed is:

1. A process of constructing a structure having a superconducting electromagnetic material as the structural core, comprising:
forming a flexible carbon nanotube/graphene or a hybrid carbon fiber/graphite composite laminar material;
making carbon nanotube/graphene or a hybrid carbon fiber/graphite composite laminar material a controllable superconducting electromagnet and or a superconducting magnet along its plane or through its cross section;
spraying a face of the carbon nanotube/graphene or a hybrid carbon fiber/graphite composite laminar material with a coating to provide treated material; and
having the treated carbon nanotube/graphene or a hybrid carbon fiber/graphite composite laminar material act as a linear synchronous motor and forming into a structure,
wherein the structure may be rigidified by electrifying the carbon nanotube/graphene or hybrid carbon fiber/graphite composite laminar material and automating the construction process with the use of electricity including exterior façade finishes of a building and or structure.

2. The process of claim 1, further comprising spraying the carbon nanotube/graphene or hybrid carbon fiber/graphite composite laminar material with a second coating over the first coating to provide treated/graphene or hybrid carbon fiber/graphite composite laminar material.

3. The process of claim 2, further comprising spraying the carbon nanotube/graphene or hybrid carbon fiber/graphite composite laminar material with a third coating on an opposing face of the carbon nanotube material from the first layer.

4. The process of claim 1, wherein the first coating is an epoxy/resin coating.

5. The process of claim 2, wherein the second coating is an epoxy/resin coating also to act as a seamless ‘drywall’ interior finish ready for paint in a building.

6. The process of claim 3, wherein the third coating is a boron nitride coating also to act as a seamless ‘drywall’ interior finish ready for paint in a building.

7. The process of claim 2, further including rigidifying and or erecting the structure on or off site by electrifying the carbon nanotube/graphene or hybrid carbon fiber/graphite composite laminar material and holding the structure rigid until the second coating has cured.

8. The process of claim 1, wherein the flexible carbon nanotube/graphene or hybrid carbon fiber/graphite material is at least two laminar ply's of carbon nanotube/graphene or hybrid carbon fiber/graphite composite laminar material, and forming the treated carbon nanotube/graphene or hybrid carbon fiber/graphite composite laminar material into a structure includes joining the at least two sheets of carbon nanotube/graphene or hybrid carbon fiber/graphite composite laminar material by stitching the at least two sheets of carbon nanotube/graphene or hybrid carbon fiber/graphite composite laminar material to one another.

9. The process of claim 8, wherein forming the treated carbon nanotube/graphene or hybrid carbon fiber/graphite composite laminar material into a structure further includes forming carbon nanotube/graphene or hybrid carbon fiber/graphite composite laminar material core columns by layering at least two carbon nanotube/graphene or hybrid carbon fiber/graphite composite laminar sheets, the at least two carbon nanotube/graphene or hybrid carbon fiber/graphite composite laminar sheets layered together and immersed in the epoxy/resin, and forming an outer shell of the core column of a carbon nanotube/graphene or hybrid carbon fiber/graphite composite laminar material.

10. The process of claim 8, wherein forming the treated carbon nanotube/graphene or hybrid carbon fiber/graphite composite laminar material into a structure further includes forming load bearing components of at least one carbon nanotube/graphene or hybrid carbon fiber/graphite composite laminar material guide rail and an outer shell of carbon nanotube/graphene or hybrid carbon fiber/graphite composite laminar ply acting as a formwork to be filled with conventional structural concrete.

11. The process of claim 1, wherein the carbon nanotube/graphene or hybrid carbon fiber/graphite composite laminar material includes integrated resistors, transformers, capacitors, transistors, magnetic amplifiers, sensors and relays to control voltage, amps and magnetic fields within the material.

12. The process of claim 1, wherein the carbon nanotube/graphene or hybrid carbon fiber/graphite composite laminar structure automates the installation of the exterior façade finishes.

13. The process of claim 1, wherein forming the treated carbon nanotube/graphene or hybrid carbon fiber/graphite composite laminar material into a structure further comprises forming the structure to form carbon nanotube/graphene or hybrid carbon fiber/graphite composite laminar material actuators from segmented carbon nanotube/graphene or hybrid carbon fiber/graphite composite laminar material components.

14. The process of claim 1, wherein forming the treated carbon nanotube/graphene or hybrid carbon fiber/graphite composite laminar material into a structure includes creating carbon nanotube/graphene or hybrid carbon fiber/graphite composite laminar exoskeleton rough-ins for one or more of refrigeration plumbing lines for cooling the superconductive properties of the carbon nanotube structural core, HVAC, Plumbing, Electrical, Communications, and Security applications.

15. The process of claim 1, wherein forming the treated carbon nanotube/graphene or hybrid carbon fiber/graphite composite laminar material into a structure further includes hooking at least one battery up to the treated carbon nanotube/graphene or hybrid carbon fiber/graphite composite laminar material.

16. The process of claim 1, wherein forming the treated carbon nanotube/graphene or hybrid carbon fiber/graphite composite laminar material into a structure further includes erecting shielding around the construction site.

17. The process of claim 16, wherein the shielding is EMF/EMI (electromagnetic field and electromagnetic interference), debris, weather and heat shielding.

18. The process of claim 9, wherein gaps between the at least two fins contain an insulation.

19. The process of claim 18, wherein the insulation is a boron nitride insulation or equivalent coating with properties of non-conductivity and high thermal insulation.

20. The process of claim 1, wherein forming the treated carbon nanotube/graphene or hybrid carbon fiber/graphite composite laminar material into a structure further includes rigidifying the structure and securing façade slabs to the exterior of the structure using magnetic fields to attract exterior cladding, with built-in permanent magnets, to the plane of the building envelope and propel and fix façade cladding into their designed locations by remotely controlling the automation sequencing.

21. The process of claim 1, wherein forming the treated carbon nanotube/graphene or hybrid carbon fiber/graphite composite laminar material into a structure further includes rigidifying the structure and having superconducting electromagnetic core act as a supercapacitor and capabilities of wirelessly charging.

22. The process of claim 1, wherein forming the treated carbon nanotube/graphene or hybrid carbon fiber/graphite composite laminar material into a structure further includes rigidifying the core structure but having other building components having more of an aerogel/elastic consistency and capable of transforming in shape.

23. The process of claim 1, wherein forming the treated carbon nanotube/graphene or hybrid carbon fiber/graphite composite laminar material into a structure further includes rigidifying the structure and enabling elevators, conveyors, escalators to move, propel and levitate using the superconducting electromagnetic core.

24. The process of claim 1, wherein the treated, lightweight, tensioned and electromagnetic carbon nanotube/graphene or hybrid carbon fiber/graphite composite laminar material and its magnetic field interactions, once an electrical current is introduced into the system, will provide the necessary compressive and tensile strength required to construct a building or structure as compared to conventional concrete, structural steel and or wood.

25. A building CNT/graphene or hybrid carbon fiber/graphite composite laminar core body prepared by a process according to claim 1.
